(19) United States
(12) Patent Application Publication
(10) Pub. No.: US 2026/0156201 A1
(43) Pub. Date: Jun. 4, 2026

(54) ENHANCED NOTIFICATIONS FOR ELECTRONIC SHELF LABEL SYSTEMS

(71) Applicant: QUALCOMM Incorporated, San Diego, CA (US)

(72) Inventors: Varun Amar Reddy, San Diego, CA (US); Sony Akkarakaran, Poway, CA (US)

(21) Appl. No.: 18/966,875

(22) Filed: Dec. 3, 2024

(51) Int. Cl. H04L 67/55; G09F 3/20; H04W 4/02

(52) U.S. Cl. CPC H04L 67/55; G09F 3/208; H04W 4/02

(57) ABSTRACT

This disclosure provides systems, methods, and devices for Electronic Shelf Label (ESL) systems that support enhanced notification coexistence techniques. In a first aspect, a device includes a processor and a memory. The processor is configured to cause the device to receive a first ESL notification request from a first device associated with a first ESL and to receive a second ESL notification request from a second device associated with a second ESL. The processor is also configured to cause the device to determine whether locations of the first ESL and the second ESL satisfy a proximity condition. The processor is further configured to cause the device to transmit ESL notification indication information for the first ESL and the second ESL that indicates a first notification for the first ESL different from a second notification for the second ESL. Other aspects and features are also claimed and described.

### TECHNICAL FIELD

Aspects of the present disclosure relate generally to wireless communication systems, and more particularly, to electronic shelf label (ESL) systems. Some features may enable and provide improved notifications for ESL system, including flexible notification coexistence schemes for ESL systems.

### INTRODUCTION

In general, retail stores use paper labels to display information about products displayed on shelves, such as prices, discount rates, unit costs, origins, or the like. Using such paper labels for the price display has limitations. For example, when there are changes in product information or locations on shelves, the retailer must generate new paper labels and discard old ones. This raises costs for maintenance in both supplies and employee labor. Further, in environmental terms, replacing the labels wastes raw materials such as paper, which adversely affects the protection of the environment. Still further, humans are prone to make mistakes, such as mislabeling a shelf or product or forgetting to take down temporary price changes on certain shelving, which results in shopper frustration.

Electronic shelf label (ESL) devices are electronic devices for displaying price information for items on retail store shelves, which may be used in place of paper labels. ESL devices may be attached to a front edge of retail shelving and display a variety of pricing information using display devices, such as Liquid Crystal Displays (LCD). Whenever the information about a product or the location of a product is changed, the ESL device may be programmed with new product information. Thus, the electronic shelf label can be repeatedly used.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Electronic shelf label (ESL) devices may be used in a wireless network to provide information and services to shoppers and retailers (as users of an ESL system). For example, ESL devices operating on a wireless network as part of ESL system may support position location services to identify the location of ESLs devices and/or assets within an environment (e.g., a retail store, warehouse, storage area, etc.). As another example, the ESL system may support position location services to identify a position of users within the environment by interacting with the user's mobile device. Such position/location services and information can be used to facilitate notification and/or navigation requests. Example embodiments provide for enhanced notification coexistence operations which enable a more flexible and adaptable notification scheme for providing multiple notifications in close proximity to multiple users. The enhancements may utilize notification proximity determination operations and proximity-based notification generation and/or adjustment operations.

In one aspect of the disclosure, a device for wireless communication includes at least one processor and a memory coupled to the at least one processor. The at least one processor is configured to cause the device to: receive a first electronic shelf label (ESL) notification request from a first device associated with a first ESL; receive a second ESL notification request from a second device associated with a second ESL; determine whether a first location of the first ESL and a second location of the second ESL satisfy a proximity condition; and transmit ESL notification indication information for the first ESL and the second ESL responsive to determining that the proximity condition is satisfied, the ESL notification indication information indicating a first notification for the first ESL different from a second notification for the second ESL.

In an additional aspect of the disclosure, a device for wireless communication includes at least one processor and a memory coupled to the at least one processor. The at least one processor is configured to cause the device to: receive a first electronic shelf label (ESL) notification request from a first device associated with a first ESL; receive a second ESL notification request from a second device associated with a second ESL; transmit notification report information indicating the first ESL notification request and the second ESL notification request, wherein a first location of the first ESL and a second location of the second ESL satisfy a proximity condition; and receive ESL notification indication information for the first ESL and the second ESL responsive to transmission of the notification report information, the ESL notification indication information indicating a first notification for the first ESL different from a second notification for the second ESL based on the proximity condition being satisfied.

In an additional aspect of the disclosure, a device for wireless communication includes at least one processor and a memory coupled to the at least one processor. The at least one processor is configured to cause the device to: receive ESL notification indication information for a first ESL and a second ESL, the ESL notification indication information indicating a first notification for the first ESL different from a second notification for the second ESL based on a first location of the first ESL and a second location of the second ESL satisfying a proximity condition for ESL notifications; and instruct the first ESL to output the first notification via the first ESL.

In an additional aspect of the disclosure, a device for wireless communication includes at least one processor and a memory coupled to the at least one processor. The at least one processor is configured to cause the device to: transmit a first electronic shelf label (ESL) notification request associated with a first ESL; and receive ESL notification indication information for the first ESL and a second ESL responsive to transmission of the first ESL notification request, the ESL notification indication information indicating a first notification for the first ESL different from a second notification for a second ESL based on a first location of the first ESL and a second location of the second ESL satisfying a proximity condition for ESL notifications.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

Devices, networks, and systems may be configured to communicate via one or more portions of the electromagnetic spectrum. The present disclosure describes certain aspects with reference to certain communications technologies, such as Bluetooth or Wi-Fi. However, the description is not intended to be limited to a specific technology or application, and one or more aspects described with reference to one technology may be understood to be applicable to another technology. Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus, and methods described herein may be applied to other communications systems and applications than the particular examples provided.

For example, the described implementations may be implemented in any device, system, or network that is capable of transmitting and receiving RF signals according to any of the wireless communication standards, including any of the IEEE 802.11 standards, the IEEE 802.15.1 Bluetooth® standards, Bluetooth low energy (BLE), code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, 5G New Radio (5G NR), 6G, or other known signals that are used to communicate within a wireless, cellular, or internet of things (IOT) network, such as a system utilizing 3G, 4G 5G, or 6G technology, or further implementations thereof.

In various implementations, the techniques and apparatus may be used in wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably and may refer to a collection of devices capable of communicating with each other through one or more communications techniques.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, or packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.).

Implementations may range from chip-level or modular components to non-modular, non-chip-level implementations and further to aggregated, distributed, or original equipment manufacturer (OEM) devices or systems incorporating one or more described aspects. In some settings, devices incorporating described aspects and features may also include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, or constitutions.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well-known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a device is described as containing components A, B, or C, the device may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

Also, as used herein, relative terms, unless otherwise specified, may be understood to be relative to a reference by a certain amount. For example, terms such as “higher” or “lower” or “more” or “less” may be understood as higher, lower, more, or less than a reference value by a threshold amount.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1A is a block diagram illustrating an example Electronic Shelf Label (ESL) system according to some embodiments of this disclosure.

FIG. 1B is a diagram illustrating an example of a display of an ESL device according to some embodiments of this disclosure.

FIG. 2A is a perspective view of a gondola with Electronic Shelf Label (ESL) devices according to some embodiments of the disclosure.

FIG. 2B is a top-down view of a retail environment with Electronic Shelf Label (ESL) devices accessible to a user according to some embodiments of the disclosure.

FIG. 3 is a timing diagram illustrating time division multiplexing for communicating with multiple Electronic Shelf Label (ESL) devices according to some embodiments of the disclosure.

FIG. 4 is a block diagram illustrating an example ESL device according to some embodiments of this disclosure.

FIG. 5 is a block diagram illustrating an example wireless communication system that supports enhanced notification coexistence operations according to one or more aspects.

FIG. 6 is a timing diagram illustrating an example process that supports enhanced notification coexistence operations according to one or more aspects.

FIG. 7 is a timing diagram illustrating an example process that supports enhanced notification coexistence operations according to one or more aspects.

FIG. 8 is a timing diagram illustrating an example process that supports enhanced notification coexistence operations according to one or more aspects.

FIG. 9 is a diagram illustrating an example of an ESL system that supports enhanced notification coexistence operations according to one or more aspects.

FIGS. 10A-10F each illustrate an example visual notification for an ESL system that supports enhanced notification coexistence operations according to one or more aspects.

FIG. 11 is a flow diagram illustrating an example process that supports enhanced notification coexistence operations according to one or more aspects.

FIG. 12 is a flow diagram illustrating another example process that supports enhanced notification coexistence operations according to one or more aspects.

FIG. 13 is a block diagram of an example UE that supports enhanced notification according to one or more aspects.

FIG. 14 is a block diagram of an example ESL device that supports enhanced notification coexistence operations according to one or more aspects.

FIG. 15 is a timing diagram illustrating an example process that supports enhanced notification coexistence operations according to one or more aspects.

FIG. 16 is a block diagram of examples of ESL notification operations according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support enhanced Electronic Shelf Label (ESL) position based notification operations, including proximity-based notifications and notification coexistence operations. The enhanced ESL notification operations are compatible with both uplink and downlink based determination of device position within an ESL system based on ESL infrastructure, including for non-ESL devices. For example, ESL devices or non-ESL devices (e.g., UEs) can determine a position for the non-ESL devices and/or electronic tags (eTags) based on ESL wireless transmissions. The present disclosure supports enhanced notification coexistence operations that enable the system to generate and/or modify notifications based on notification/device proximity to improve notification density and reduce notification confusion.

Particular implementations of the subject matter described in this disclosure may be implemented to realize one or more of the following potential advantages or benefits. In some aspects, the present disclosure provides techniques for the determination of notification proximity and for the generation and/or adjustment of device and/or ESL notifications based on the determined proximity for notification coexistence. For example, the ESL system can generate and/or modify ESL and/or device notifications for overlapping notifications to enable two or more notifications to exist in proximity to one another. Thus, the ESL system can improve notification bandwidth by enabling more notifications to be output more clearly in a given region at one time.

In some aspects, the ESL system may utilize proximity conditions of distance, group, area, aisle, etc., when determining whether a request and/or the corresponding notification overlaps with another request or requests. For example, the ESL system may evaluate one or more priority conditions serially or in parallel to determine if one or more are satisfied. Responsive to one or more proximity conditions being satisfied, such as based on system configurations, the ESL system will determine that two (or more) notifications overlap and satisfy a proximity evaluation. When notifications are deemed to be overlapping, such that displaying the same type of notification might be confusing, the system may generate and/or adjust at least one of the notifications to improve the coexistence with the other such that both can output and function with one another.

In some aspects, the ESL system may utilize time to further determine the proximity condition or whether to evaluate for the proximity condition or conditions. To illustrate, the ESL system may use timestamps or grouped requests to determine whether to evaluate the requests for a proximity conditions. Additionally, or alternatively, the ESL system may utilize a time or estimated time for a notification when determining whether two requests and/or corresponding notifications overlap and satisfy the proximity condition or conditions. Utilizing time to further determine notification overlap increases notification bandwidth by reducing false positives and notification overlap.

Additionally, enhanced notifications are also described herein. For example, enhanced visual indications for ESLs and ESL displays are described which enable multiple indications to be displayed at once or near each other. As another example, coordination and/or synchronizing between device and ESL notifications may further enable multiple indications to be displayed at once or near each other by enabling additional linking information or feedback the device and ESL notifications to enable a user of the device to differentiate which notification is for the user from among multiple notifications being output in an area. The enhanced visual indications and notification output schemes and notification synchronization between device notifications and ESL notifications further increases notification density and bandwidth and reduce notification confusion.

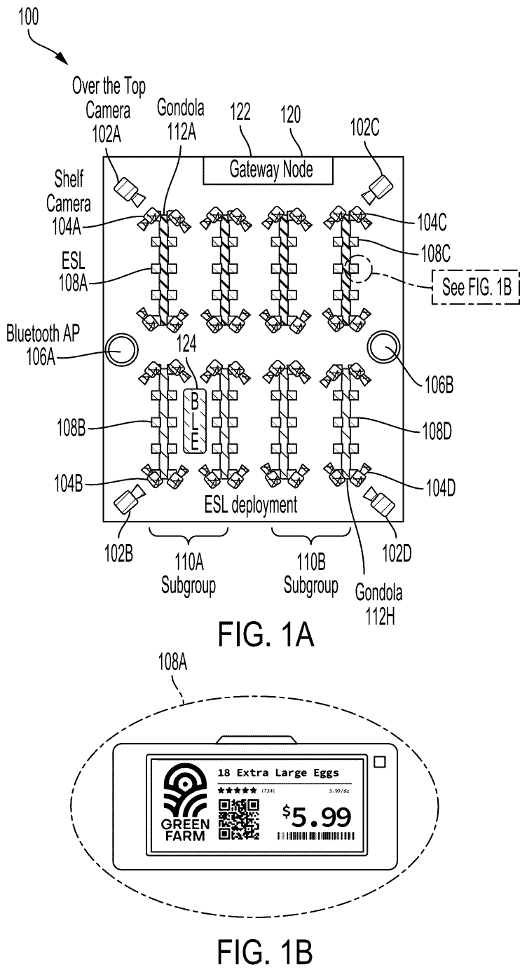

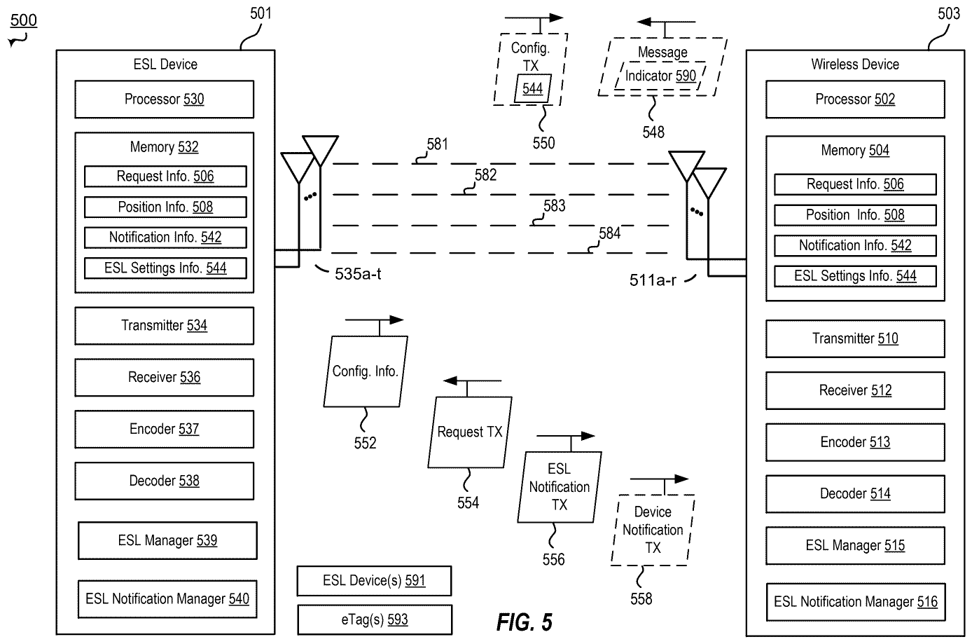

FIG. 1A is a block diagram illustrating an example Electronic Shelf Label (ESL) system according to some embodiments of this disclosure. An electronic shelf label (ESL) system 100 may include a management server 122 that is integrated with or coupled to a gateway node 120. The management server 122 may include at least one processor coupled to a memory, in which the at least one processor is configured to execute computer program code stored on a computer-readable medium to cause the management server 122 to perform operations related to managing operation of the ESL devices 108A-D, the APs 106A-106B, the gateway node 120, and/or other components within the ESL system 100. For example, the management server 122 may perform operations relating to ESL based position determination and/or generation of ESL notifications based on ESL based position determinations. For example, the management server 122 may perform operations described with reference to FIGS. 5-8.

The gateway node 120 may communicate with access point (AP) 106A and access point (AP) 106B. Although only two APs are shown in the example system, fewer or more APs may be included in the ESL system 100. The APs 106A and 106B may communicate through a first communication network, either wired or wireless, with the gateway node 120. The APs 106A and 106B also communicate through a second communication network with Electronic Shelf Label (ESL) tag devices. For example, the APs 106A and 106B may communicate with paired ESL devices in an assigned geographic area. In a first geographic assignment 110A, the AP 106A may communicate with ESL device 108A and ESL device 108B; in a second geographic assignment 110B, the AP 106B may communicate with ESL device 108C and ESL device 108D. The first and second communication networks may be different networks. In some embodiments, the first communication network for communication between AP 106A and gateway node 120 is a Wi-Fi network and the second communication network for communication between AP 106A and ESL device 108A is a Bluetooth network.

Bluetooth technology provides a secure way to connect and exchange information between electronic devices, such as smartphones, other cellular phones, headphones, earbuds, smartwatches, laptops, wearables, and/or shelf labels. Bluetooth communications may include establishing wireless personal area networks (PANs) (also referred to as “ad hoc” or “peer-to-peer” networks). These ad hoc networks are commonly called “piconets.” Each device may belong to multiple piconets. Multiple interconnected piconets may be called scatternets. A scatternet may be formed when a member of a first piconet elects to participate in a second piconet. In the example of FIG. 1A, the ESL device 108A may be in a piconet with the AP 106A.

Because many of the services offered over Bluetooth can expose private data or allow the connecting party to control the connected device, Bluetooth networks may have devices first establish a “trust relationship” before they are allowed to communicate private data to one another. This trust relationship may be established using a process referred to as “pairing,” in which a bond is formed between two devices. This bond enables the devices to communicate with each other in the future without further authentication. The ESL device 108A may be bonded in such a manner to the AP 106A. The pairing process may be triggered automatically each time the device is powered on or moved within a certain distance of another Bluetooth device. Pairing information relating to current and previously established pairings may be stored in a paired device list (PDL) in the memory of the Bluetooth device, such as the ESL device 108A and/or the AP 106A. This pairing information may include a name field, an address field, a link key field, and other similar fields (such as “profile” type) useful for authenticating the device or establishing a Bluetooth communication link. The pairing information may allow the ESL device 108A to reconnect to the AP 106A automatically when, for example, power loss causes the ESL system 100 to reset.

A Bluetooth “profile” describes general behaviors through which Bluetooth-enabled devices communicate with other Bluetooth devices. For example, the hands free profile (HFP) describes how a Bluetooth device (such as a smartphone) may place and receive calls for another Bluetooth device, and the Advanced Audio Distribution Profile (A2DP) describes how stereo-quality audio may be streamed from a first Bluetooth device (such as a smartphone) to another Bluetooth device (such as an earbud). The ESL devices 108A-108D may be configured with an Electronic Shelf Label Profile compliant with the Electronic Shelf Label Profile v1.0 dated Mar. 28, 2023, which is incorporated by reference herein. The ESL Profile may specify how the AP 106A may use one or more ESL Services exposed by the ESL device 108A.

The management server 122 may be implemented as a database (DB) server that stores and manages product information regarding products displayed in a distribution store. The management server 122 may store a variety of information used during the operation of a store, as well as product information. Furthermore, the management server 122 may write and manage command messages that are used to carry out various functions such as the synchronization, updating, and alteration of product information displayed on the ESL devices 108A-108D. The management server 122 may be provided with a database for the ESL devices 108A-108D and product information displayed on the ESL devices 108A-108D. That is, the management server 122 may be provided with a database that stores identification information relating to ESL devices 108A-108D in connection with product information displayed on a corresponding one of the ESL devices 108A-108D.

A command message, created by the management server 122 (e.g., a product-information change message or a management-information acquisition message) can be transferred to the gateway node using a message packaged into a packet suitable for a communication scheme used with the gateway node 120, and transfer the configured packet. Furthermore, the management server 122 may receive a reception acknowledgement message, sent from the gateway node 120, through the communication scheme, convert the received message into a message receivable by the management server 122, and transfer the converted message. The messages may include notifications of an ESL system determination position and/or notification instructions based on ESL determined positions as described further with reference to FIGS. 5-8.

Although only one gateway node 120 is shown in the ESL system 100, there may be several such gateway nodes communicating with the management server 122. Each gateway node 120 analyzes data received from the management server 122 confirming the presence or absence of a message or data, which is to be sent to the ESL device 108A, and then sends the confirmed message or data to the corresponding ESL device 108A. The gateway node 120 may configure a message, which is to be sent to the ESL device 108A, into a packet according to a communication scheme and send the configured packet to the ESL device 108A through commanding the AP 106A to transmit the packet. Furthermore, the gateway node 120 may transfer a reception acknowledgement message received from the ESL device 108A through the AP 106A to the management server 122.

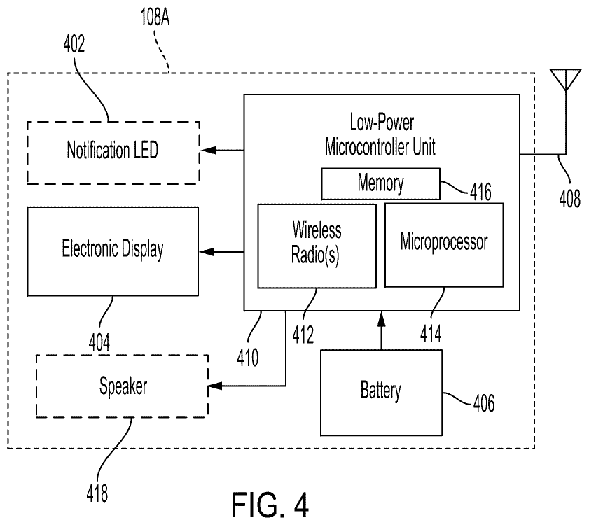

The ESL devices 108A-108D may include a plurality of ESL devices 108A-108D displaying data concerning product information received from the gateway node 120. The ESL devices 108A-D displaying product information associated with products may be attached to the shelving. One example layout of an ESL system 100 is shown across multiple gondolas 112A-112H. Each of the gondolas 112A-112H may include one or more shelves, to which the ESL devices 108A-108D are attached. The ESL device 108A-108D may be configured as shown, for example, in FIG. 4, with the microcontroller configured to perform operations described with reference to FIG. 5-8, 10, or 11.

In some embodiments, a video monitoring system may be included as part of ESL system 100 or used to augment the capabilities of the ESL system 100. For example, shelf cameras 104A-104D may be positioned with a field of view that captures one or more shelves of one or more of the gondolas 112A-112H. The shelf cameras 104A-104D may be used to assist in tracking stock levels and/or identifying items picked by users while in the environment. As another example, over-the-top (OTT) cameras 102A-102D may be positioned with a field of view capturing large regions of an environment of the ESL system 100. Object recognition systems may be applied to received image frames from the cameras 102A-D or 104A-D to determine a presence of, or count of, objects and humans in the field of view of a respective camera.

The OTT cameras 102A-102D may be used to support determination of a position of an ESL device 108A-D, user mobile device, or other devices within the environment. A mobile device supporting Bluetooth Low Energy (BLE), such as BLE device 124, may traverse the environment and communicate with the ESL devices 108A-108D, for example to receive identification information from the ESL devices 108A-108D, with the location of the ESL devices 108A-D determined by identifying a location of the BLE device 124 from the camera image frames at the time the BLE device 124 receives signals, and/or the strength of the signals, received from the ESL devices 108A-108D.

The ESL devices 108A-108D may change price information or be activated or inactivated while communicating with the gateway node 120. A store manager may send the management server 122 a command concerning the synchronization between a product and the ESL device 108A and/or a command for the correction of information regarding a product assigned to the ESL device 108A. An example ESL device display is shown inset in FIG. 1B, with such a device displaying information including a product description, a product image, a product price, a product barcode, a product rating, a product Stock Keeping Unit (SKU), and/or a product link (e.g., a URL or QR code).

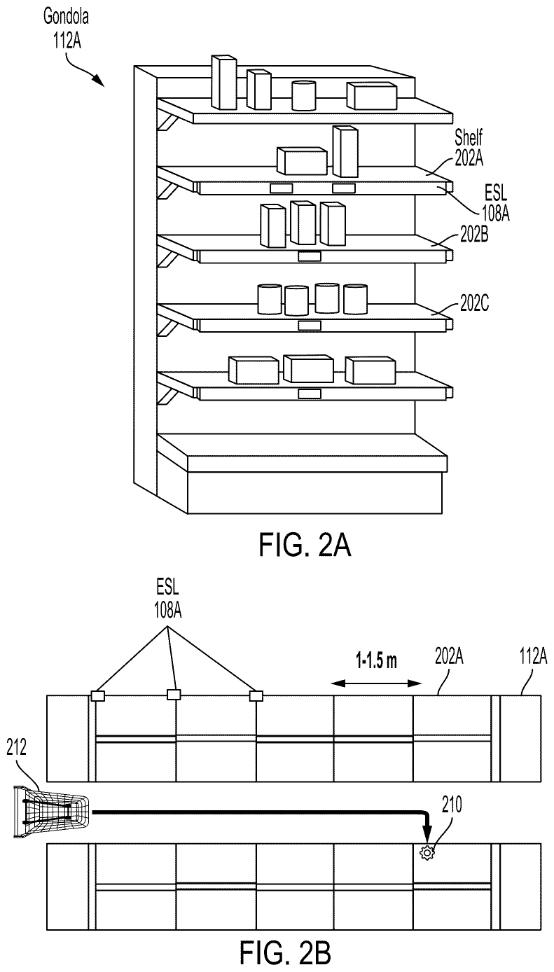

As described earlier, the environment may include ESL devices organized on gondolas and shelves. One example illustration of such an arrangement is shown in FIG. 2A. FIG. 2A is a perspective view of a gondola with Electronic Shelf Label (ESL) devices according to some embodiments of the disclosure. The gondola 112A may include multiple shelves 202A-202C at different vertical levels from a floor. ESL devices may be attached to the shelves 202A-202C. For example, ESL device 108A may be attached to shelf 202A to display information regarding products stocked on shelf 202A in the vicinity of the ESL device 108A.

The ESL devices may provide information to a shopper or store employee operating in the environment, such as to provide information regarding products and/or assist with location determination of products or the user. FIG. 2B is a top-down view of a retail environment with Electronic Shelf Label (ESL) devices accessible to a user according to some embodiments of the disclosure. A user pushing a shopping cart 212 through an aisle may use ESL devices to determine the location of a particular product. For example, a mobile device associated with the shopping cart 212 may guide a user to location 210 where stock for a desired product is located. Although retail store examples, are illustrated in FIGS. 1A-2B, in other examples the ESL environment may include or correspond to warehouse, a storage area, a home, or any place where shelves and digital labels may be used.

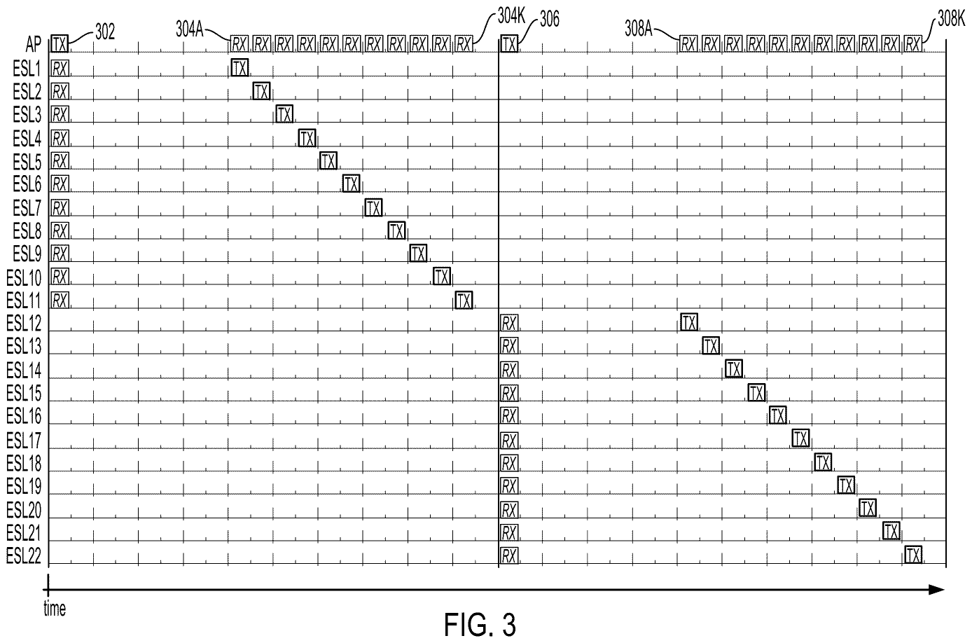

Communication within the ESL system 100 between an access point (AP) and Electronic Shelf Label (ESL) devices may be performed according to a Time Division Multiple Access (TDMA) scheme, such as one illustrated in FIG. 3. FIG. 3 is a timing diagram illustrating time division multiplexing for communicating with multiple Electronic Shelf Label (ESL) devices according to some embodiments of the disclosure. An AP, such as AP 106A, may broadcast information that is received by all ESL devices, including ESL device 108A, during a first time period 302. The ESL devices may communicate with the AP during subsequent time periods. For example, a first ESL device, such as ESL device 108A, may transmit in time period 304A, with other ESL devices transmitting in time periods 304B-304K. In ESL systems with significant numbers of ESL devices, the ESL devices may be configured to communicate in different groups. For example, ESL devices 1-11 may be configured to transmit to the AP during a first time cycle and ESL devices 12-22 may be configured to transmit to the AP during a second time cycle. The first and second time cycles may alternate during operation of the wireless network.

An ESL device may include components configured together to provide some or all of the functionality described in this disclosure and/or provide additional functionality. FIG. 4 is a block diagram illustrating an example Electronic Shelf Label (ESL) device according to some embodiments of this disclosure. The ESL device 108A may include a low-power microcontroller 410. Although functionality for the ESL device may be configured by the microcontroller 410 in embodiments of this disclosure, any single or combination of processors (e.g., at least one processor) may be used to perform the functions described according to embodiments of this disclosure.

The microcontroller 410 may include a memory 416. The memory 416 may store computer program code that causes a microcontroller 410 to execute operations that carry out some or all of the functionality described in embodiments of this disclosure. Although shown as part of the microcontroller 410, the memory 416 may be located internal to or external to the microcontroller 410. The microcontroller 410 may also include one or more wireless radio(s) 412. The wireless radios 412 may include, for example, a Bluetooth wireless radio including a front end that couples to antenna 408 for transmitting and receiving radio frequency (RF) signals at one or more frequencies in one or more frequency bands. In some embodiments, the microcontroller 410 is a System on Chip (SoC) in which two or more components of the wireless radio(s) 412, the microprocessor 414, and/or the memory 416 are included in a single semiconductor package. In some embodiments, the two or more components may be included on a single semiconductor die.

The ESL device 108A may include I/O devices, such as a notification LED 402 and/or an electronic display 404. The notification LED 402 may include one or more light emitting diodes (LEDs), or other light sources configured to flashlight of one or more colors. The notification LED may be triggered to blink at a specific time and/or with a specific color based on a command received from the gateway node 120. For example, a notification LED 402 may blink to attract a user's attention to a particular location on a shelf. The electronic display 404 may be, for example, an electronic-ink (e-Ink) display configured to output the product information. In some implementations, the ESL device 108A may include a speaker 418. The speaker 418 may include one or more audio output devices configured to output audio signals. For example, the speaker 418 may output tones, beeps, bell or chime sounds, or speech.

The ESL device 108A may couple to a battery 406 or other power source to power operations performed by the ESL device 108A, such as to operate the wireless radio(s) 412, the notification LED 402, the electronic display 404, the memory 416, the speaker 418, and/or the microprocessor 414. The battery 406 may allow placement of the ESL device 108A in a place where constant power supply is difficult. Thus, in order that a single battery charge provides a long period of use (e.g., lasting longer than several years), the ESL device 108 may be configured to reduce power consumption during times when frequent commands are not expected. For example, the ESL device 108A may operate using a wakeup communication scheme. That is, the ESL device 108A wakes up according to predetermined time intervals to determine whether data is waiting to be received. When no data is waiting, power to the ESL device 108A is turned off until the next wakeup period to reduce power consumption. When there is data to be received, the ESL device 108A wakes up to perform communication operations.

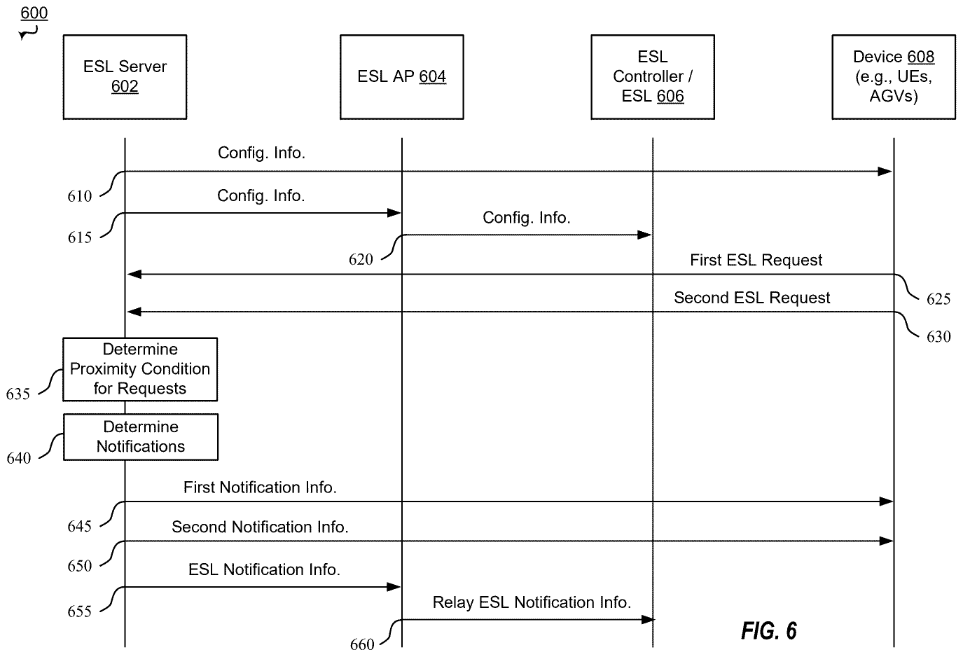

It is noted that one or more blocks (or operations) described with reference to FIGS. 1-4 may be combined with one or more blocks (or operations) described with reference to another of the figures. For example, one or more blocks (or operations) of FIG. 5 may be combined with one or more blocks (or operations) of FIGS. 1-4. As another example, one or more blocks associated with FIG. 6 may be combined with one or more blocks associated with FIGS. 1-4.

In certain scenarios, RSSI (Received Signal Strength Indicator) measurements can be obtained by a device to estimate its position. Some examples of such scenarios include position estimation for or by low-cost devices or anchor node infrastructure which cannot make perform time-of-arrival (ToA) or angle-of-arrival (AoA) measurements that require advanced processing capability. Electronic Shelf Label (ESL) infrastructure is one such example and presents a highly-dense network of anchor nodes that can achieve sub-meter accuracy in retail-store settings, albeit with constraints on power consumption (since they are often battery-powered).

Enhanced DL-based positioning schemes can adapt the beaconing rate for an ESL radio based on its distance from a target device. Such a scheme would be compatible with mobile devices capable of decoding the ESL radios' beacons and measuring their RSSI. However, in order to determine a position of ambient IoT energy-harvesting eTags, which cannot decode ESL radio beacons, a different UL-based positioning determination approach may be required where the ESL radios wake up to receive beacons from the eTags′. To serve both types of devices (smartphones and eTags), a combination of both DL and UL schemes could be to be deployed.

In such dense networks, a plurality of users, such as workers and/or shippers, may make notification requests based on the determined positions of their devices and of the ESL devices as described above. However, current ESL systems and the constraints of the ESL themselves may not be able to support displaying notifications for all such requests clearly and simultaneously, and the system may become overburden with ESL requests and may not be able to display all such requests in a clear manner. To illustrate, some proposed solutions of using a particular color LED coupled to or associated with the ESL to indicate requests may not be able to support a larger number of users clearly in a dense network of devices.

In the aspects described herein, enhanced notification coexistence schemes are disclosed for enabling the ESL system to leverage the capabilities of ESL and devices to output more notifications more clearly in a defined space at one time. The enhanced notification coexistence schemes may include determining whether two or more notifications overlap based on one or more proximity conditions being satisfied. When a proximity condition or conditions are satisfied, the ESL system may engage in notification coexistence operations to generate and/or adjustment notifications to be output by ESL devices. For example, the ESL system can generate unique notifications for multiple users in one area using visual pattern based notifications and optionally in combination with audio outputs, haptic feedback, and/or other visual indicators (e.g., LEDs). As one illustration, the system can generate multiple unique visual patterns, such as a flashing green display with a particular cadence and a flashing red display with a different cadence. Such visual indications may be unique to the user, and the device of the requesting user may output a similar notification that is synched with the visual pattern or notification output by the ESL. Additionally, by using visual patterns and/or using the ESL display itself (or reserved areas of the display) to output the visual notification, additional and more complex notifications can be provided to improve notification clarity and density.

FIG. 5 illustrates an example of a wireless communications system 500 that supports enhanced ESL notification coexistence operations and ESL position based notification operations in accordance with aspects of the present disclosure. In some examples, the wireless communications system 500 may implement aspects of ESL system 100. For example, the wireless communications system 500 may include an ESL network, such as ESL infrastructure including one or more ESL devices or network entities, and one or more wireless devices which interact with the ESL infrastructure. The wireless devices may include UEs, such as cell phones, employee smart devices, automated guided vehicles (AGVs), robots, smart glasses, smart watches, tablets, augmented reality devices, extended reality devices, etc. As illustrated in the example of FIG. 5, the wireless communications system 500 includes an ESL device 501 and a wireless device 503.

The ESL device 501 may include or correspond to any of the ESL devices or infrastructure described herein, including the gateway node 120, the management server 122, an ESL AP (e.g., the AP 106A or 106B), an ESL device or controller (e.g., ESL devices 108C or 108D), or the ESL device 400 of FIG. 4. An ESL controller may include one or more ESL devices and a wireless radio and be referred to as an ESL rail controller.

The wireless device 503 may include or correspond to a UE that interacts with ESL infrastructure, or to a second ESL device. The UE may be part of the ESL infrastructure or separate from the ESL infracted. For example, the UE may be associated with a worker or a robot, or with a customer/shopper. The second ESL device may include any of the ESL devices of ESL device 501 and may include or correspond to a different type of ESL device from the ESL device 501. As illustrative, non-limiting examples, the ESL device 501 may include or correspond to an ESL controller associated with one or more ESLs and the wireless device 503 may include or correspond to an ESL AP, an ESL server, or an IoT tag associated with a product or asset of the ESL network.

As illustrated in the example of FIG. 5, the wireless communications system 500 may further include one or more ESL devices 591 (e.g., second ESL devices), one or more eTags 593 (e.g., IoT tags or ESL tags). The one or more ESL devices 591 may include or correspond to an ESL device which is the same type as or a different type from a type of the ESL device 501, a type of the wireless device 503, or both. The eTags 593 may include or correspond to passive or battery-less radios which may output a signal or beacon based on received RF energy. The eTags 593 may be coupled to or associated with one or more products or assets of the ESL system. In a particular implementation, the one or more ESL devices 591 may include an energizer device configured to provide RF energy to the eTags 593 and/or trigger the eTags 593 to broadcast beacons for measurement.

Enhanced ESL notification coexistence operations for ESL position based notification operations may provide additional functionality for the ESL network and devices which interact with the ESL network. For example, enhanced ESL notification coexistence operations may enable the ESL system to improve notification bandwidth and clarity to more clearly provide more notifications in a particular area over a time period. Accordingly, ESL network and device performance can be increased.

ESL device 501 and wireless device 503 may be configured to communicate via one or more portions of the electromagnetic spectrum. For example, the ESL device 501, the wireless device 503, or both, may be configured to communicate via one or more portions of the electromagnetic spectrum associated with Bluetooth transmissions, Wi-Fi transmissions, or cellular transmissions (including sub-6 GHz and 6 GHz).

ESL device 501 and wireless device 503 may be configured to communicate via one or more channels or component carriers (CCs), such as representative first channel 581, second channel 582, third channel 583, and fourth channel 584. Although four channels are shown, this is for illustration only, more or fewer than four channels may be used. One or more channels may be used to communicate control channel transmissions, data channel transmissions, and/or sidelink channel transmissions.

Each channel or CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more channels or CCs may have or be assigned to a Cell ID, or a Bandwidth Part (BWP) ID. The Cell ID may include a unique cell ID for the channel or CC, a virtual Cell ID, or a particular Cell ID of a particular channel or CC of the plurality of channels or CCs. Additionally, or alternatively, one or more channels or CCs may have or be assigned to a HARQ ID. Each channel or CC may also have corresponding management functionalities, such as, beam management or BWP switching functionality. In some implementations, two or more channels or CCs are quasi co-located, such that the channels or CCs have the same beam and/or same symbol.

In some implementations, control information may be communicated via ESL device 501 and wireless device 503. For example, the control information may be communicated using Bluetooth transmissions, Wi-Fi transmission, MAC-CE transmissions, RRC transmissions, DCI (downlink control information) transmissions, UCI (uplink control information) transmissions, SCI (sidelink control information) transmissions, another transmission, or a combination thereof.

Wireless device 503 can include a variety of components (e.g., structural, hardware components) used for carrying out one or more functions described herein. For example, these components can include processor 502, memory 504, transmitter 510, receiver 512, encoder, 513, decoder 514, ESL manager 515, ESL notification manager 516, and antennas 511a-r. Processor 502 may be configured to execute instructions stored at memory 504 to perform the operations described herein. In some implementations, processor 502 includes or corresponds to the microcontroller unit 410 and/or the microprocessor 414 of FIG. 4, and memory 504 includes or corresponds to the memory 416 of FIG. 4. Memory 504 may also be configured to store request information 506, position information 508, notification information 542, ESL settings information 544, or a combination thereof, as further described herein.

The request information 506 includes or corresponds to data associated with or corresponding to an ESL position-based notification request for the ESL system. For example, the request information 506 (e.g., ESL notification request information) may include data which indicates or identifies a requested position of an ESL, an eTag, a location, or an employee device associated with the ESL system. The request information 506 may identify the requesting device, the requested position, the requested device/assets, and/or the requested notification type (e.g., visual, audio, etc.). The request information 506 may also identify the time of the request, a priority associated with the request, a notification time for the request, or a combination thereof.

The position information 508 includes or corresponds to data associated with or corresponding to a position or location of a non-ESL device, such as wireless device 503. For example, the position information 508 (e.g., device position information) may include data which indicates or identifies a position of a non-ESL device. To illustrate, the device position information may include positioning information which indicates a position of the device, i.e., position information, or positioning information which may be used to derive the position of the device, such as measurement information. The device position information may enable the generation of notifications (e.g., notification information, indications and/or instructions).

Additionally, the position information 508 includes or corresponds to data associated with or corresponding to a position or location of one or more ESL devices, such as one or more of any of ESL device 501, ESL devices 591, or eTags 593. For example, the position information 508 (e.g., ESL position information) may include data which indicates or identifies a position of an ESL device, or an asset associated with an ESL system.

The measurement information includes or corresponds to data associated with or corresponding to measurements of wireless signals of the wireless communications system 500. For example, the measurement information may include measurement data or measurement values associated with transmissions (e.g., Bluetooth or Wi-Fi transmissions) of the wireless communications system 500 and may enable the generation of position/location information. The measurement information may include signal strength or quality measurements, such as Reference Signal Receive Power (RSRP), Reference Signal Receive Quality (RSRQ), RSSI, etc. Additionally, or alternatively, the measurement information may include directionality information, such as AoA or beam information.

The notification information 542 includes or corresponds to data associated with or corresponding to notifications for devices or assets of or associated with the wireless communications system 500. For example, the notification information 542 may include notifications for assets of the wireless communications system 500. To illustrate, the notification may indicate a position and/or status of an IoT tag coupled to an asset, a position and/or status of an ESL of the ESL system, or a position of a location or area of the ESL system. As illustrative examples, the notification may indicate asset moved, asset misplaced, asset stolen, asset not responding, directions to an asset, an ESL, or an area, etc.

As another example, the notification information 542 may include notifications for devices of the wireless communications system 500. To illustrate, the notification information 542 may include notifications for the ESL device 501, the wireless device 503, or both. In some such implementations, the notifications for devices of the wireless communications system 500 may include notifications for or to be outputted by an ESL, and which provide a notification to a UE associated with the wireless communications system 500.

Additionally, or alternatively, the notification information includes notification conditions or thresholds, such as notification condition information or notification thresholds information, for determining a notification or when to transmit a notification. In some implementations, the notification information includes notification history information and/or notification filtering information. The notification history information may include past notifications for devices or assets of the ESL system and the notification filtering information may indicate when to not determine notifications and/or when to not send notifications, such as when restocking or performing another ESL system task.

The ESL settings information 544 includes or corresponds to data associated with enhanced ESL notification coexistence operations and/or enhanced ESL position based notification operations. The ESL settings information 544 may include one or more types of enhanced ESL position determination operation modes and/or enhanced ESL position based notification operation modes and/or thresholds or conditions for switching between such enhanced modes and/or configurations thereof. For example, the ESL settings information 544 may have data indicating different thresholds and/or conditions for different enhanced ESL position determination modes and/or enhanced ESL position based notification modes, or a combination thereof, such as for notification coexistence operations and modes thereof.

In some aspects, the ESL settings information 544 further includes or corresponds scheduling information for the ESL system. The scheduling information includes or corresponds to data associated with or corresponding to transmission timing information of the wireless communications system 500, such as for position determination operations, notification request operations, and/or notification indication operations. For example, the scheduling information may include data indicating or identifying transmission windows, such as UL and/or DL slots, transmit opportunities or both. The scheduling information may optionally include grant information, such as transmission grants.

Additionally, or alternatively, the ESL settings information 544 includes asset information, ESL device information, gondola information, store information, ESL transmission timing information (e.g., beacon timing information), UL and/or DL position determination modes, associated UE information, or a combination thereof.

Transmitter 510 is configured to transmit data to one or more other devices, and receiver 512 is configured to receive data from one or more other devices. For example, transmitter 510 may transmit data, and receiver 512 may receive data, via a network, such as a wired network, a wireless network, or a combination thereof. For example, wireless device 503 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 510 and receiver 512 may be replaced with a transceiver. Additionally, or alternatively, transmitter 510 or receiver 512 may include or correspond to one or more components of ESL device 108A described with reference to FIG. 4.

Encoder 513 and decoder 514 may be configured to encode and decode data for transmission. ESL manager 515 may be configured to perform enhanced notification coexistence operations. For example, the ESL manager 515 may be configured to manage one or more ESL related services, such as to generate ESL position based requests and process ESL notifications based on ESL based positions. The ESL manager 515 may be configured to generate ESL position based requests or request information based on measurement information, position information, time information, or a combination thereof.

The ESL manager 539 may include an ESL positioning manager configured to perform ESL measurement and position determination operations. For example, the ESL positioning manager may be configured to measure ESL transmissions (e.g., beacons) and determine measurement information based on ESL information and transmissions. As another example, the ESL positioning manager may be configured to determine one or more positions of itself or other devices based on measurements of beacons and/or reference signal(s), the measurement information. Additionally, the ESL positioning manager may be configured to determine position or location information of other ESL devices from ESL transmissions. The position information may be used to determine notification request information.

In some implementations, the ESL positioning manager may include or correspond to an ESL measurement manager may be configured to perform ESL position measurement and management operations. For example, the ESL measurement manager may be configured to measure received reference signals or beacons (e.g., beacons and/or beacon responses) to determine wireless information, measurement information, or both. The measurement information may be used to determine position information.

The ESL manager 539 may also include an ESL notification manager 516 configured to perform ESL notification request and management operations. For example, the ESL notification manager 516 may be configured to generate and/or transmit enhanced ESL notification requests, such as ESL notification requests for or based on ESL based or determined positions. Additionally, the ESL notification manager 516 may be configured to perform ESL notification synchronization operations. For example, the ESL notification manager 516 may cause the wireless device 503 to output notifications that are synchronized with notifications from ESL devices.

Although one wireless device (i.e., wireless device 503) is shown in the example of FIG. 5, in other implementations the network may include additional wireless devices which interact with the ESL infrastructure (e.g., ESL device 501). The other wireless device or devices may include one or more elements similar to wireless device 503. In some implementations, the wireless device 503 and the other wireless device or devices are different types of UEs. For example, either UE may be a higher quality or have different operating constraints. To illustrate, one of the UEs may have a larger form factor or be a current generation device, and thus have more advanced capabilities and/or reduced battery constraints, higher processing constraints, etc. As another example, one UE may be associated with a person and the other UE may be associated with a robot or autonomous device.

ESL device 501 includes processor 530, memory 532, transmitter 534, receiver 536, encoder 537, decoder 538, ESL manager 539, ESL notification manager 540, and antennas 535a-t. Processor 530 may be configured to execute instructions stores at memory 532 to perform the operations described herein. In some implementations, processor 530 includes or corresponds to low-power microcontroller unit 410 and/or microprocessor 414, and memory 532 includes or corresponds to memory 416 of FIG. 4. Memory 532 may be configured to store request information 506, position information 508, notification information 542, ESL settings information 546, or a combination thereof, and optionally other information such as described with reference to the wireless device 503 and as further described herein.

The position information 508 includes or corresponds to data associated with or corresponding to a position of an ESL device, such as ESL device 591 or eTag 593, a position of a non-ESL device, such as wireless device 503, or both. For example, the position information 508 may include data which indicates or identifies a position of a non-ESL device. To illustrate, the position information 508 may include positioning information which indicates a position of the device, i.e., position information, or positioning information which may be used to derive the position of the device, such as measurement information. The position information 508 may enable the generation of notifications (e.g., notification information, indications and/or instructions).

In some aspects, the notification information 542, the ESL settings information 544, or both include notification coexistence information. For example, the notification coexistence information includes or corresponds to data associated with generating or adjusting notifications for coexistence with one another, such as how to generate or adjust notification parameters such that multiple notifications can be clearly output without confusion or with less confusion in a particular area. With respect to the notification information 542, the notification coexistence information may include information for how to generate or adjust the output of the notification to ensure the notification does not cause confusion and is discernable from other notifications determined to be in close proximity/overlapping with the original notification. With respect to the ESL settings information 544, the notification coexistence information may include parameters or settings for how to determine if notifications are overlapping/in proximity, include parameters or settings for how to generate notification parameters for overlapping notifications, and/or may include data indication notification output capabilities of ESL devices, non-ESL devices or both. As illustrative examples, the notification coexistence information of the ESL settings information 544 may include conditions or thresholds for determining if two applications overlap, and such are further described with reference to FIGS. 6-9, conditions for generating what type of notification to generate based on the amount and type of overlapping notifications, and/or information indication what notifications the ESLs can output and the requesting user devices can output.

Transmitter 534 is configured to transmit data to one or more other devices, and receiver 536 is configured to receive data from one or more other devices. For example, transmitter 534 may transmit data, and receiver 536 may receive data, via a network, such as a wired network, a wireless network, or a combination thereof. For example, UEs and/or ESL device 501 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 534 and receiver 536 may be replaced with a transceiver. Additionally, or alternatively, transmitter 534 or receiver 536 may include or correspond to one or more components of ESL device 108A described with reference to FIG. 4.

Encoder 537, and decoder 538 may include the same functionality as described with reference to encoder 513 and decoder 514, respectively. ESL manager 539 may be configured to perform enhanced ESL position based operations, including enhanced notification coexistence operations, and may include similar functionality as to ESL manager 515. The ESL manager 539 may be configured to obtain initial ESL device position information indicating device positions of ESL devices, to generate and distributed ESL configuration or setup information, to transmit beacon start transmissions and/or beacon transmission, or a combination thereof. As another example, the ESL manager 539 may be configured to determine ESL based positions for ESL devices or ESL assets and non-ESL devices and/or determine ESL notifications based on ESL based positions.

In some implementations, the ESL manager 539 may be configured to generate notifications or notification information based on measurement information, position information, request information, time information, or a combination thereof. The ESL manager 539 may include an ESL notification manager 540 configured to perform ESL notification determination and management operations. For example, the ESL notification manager may be configured to generate and/or transmit enhanced ESL notifications, such as ESL notifications based on ESL based or determined positions. The ESL notification manager may be configured to determine notifications for assets, determine when and how to send the determined notifications, determine whether to send the determined notifications, determine notification coexistence information for assets, or a combination thereof. Additionally, the ESL notification manager may be configured to generation instructions for causing other ESL devices and/or UEs to output notifications, such as visual or auditory outputs, to provide a notification, such as directions, to a user or a UE. In some implementations, the ESL notification manager may include a notification filter configured to filter the generation and/or transmission of notifications.

The ESL notification manager 540 may include similar functionality as described with reference to the ESL notification manager 516. For example, the ESL notification manager 540 may be configured to perform ESL notification synchronization operations. Additionally, the ESL notification manager 540 may be configured to perform notification coexistence operations. For example, the ESL notification manager 540 may be configured to generate notifications that can coexist based on a notification proximity condition being satisfied based on position information of ESL devices or areas associated with position-based notification requests.

The ESL manager 539 may also be configured to perform ESL position determination operations. For example, the ESL manager 539 (or an ESL positioning manager thereof) may be configured to determine a position of a device (e.g., non-ESL device) based on ESL beacon transmission measurements (measurement information) from the device. The ESL manager 539 may utilize the position information to determine if multiple notifications satisfy a notification proximity condition.

In some implementations, the ESL device 501 may include similar functionality as described with reference to the ESL manager 515, the ESL notification manager 516, or both, of the wireless device 503. Additionally, or alternatively, the wireless device 503 may include similar functionality as described with reference to the ESL manager 539, the ESL notification manager 540, or both, of the ESL device 501.

During operation of wireless communications system 500, the network (e.g., ESL device 501) may determine that wireless device 503 has ESL notification coexistence capability and/or ESL position based notification capability. For example, wireless device 503 may transmit a message 548 that includes an ESL notification coexistence and/or ESL position based notification indicator 590 (e.g., an enhanced notification coexistence indicator). Indicator 590 may indicate ESL enhanced notification coexistence for one or more communication modes, such as uplink, downlink, sidelink, etc. In some implementations, an ESL network entity (e.g., the ESL device 501) sends control information to indicate to the wireless device 503 that enhanced ESL enhanced notification coexistence operations and/or a particular type of enhanced ESL notification coexistence operation is to be used. For example, in some implementations, configuration transmission 550 is transmitted to the wireless device 503. The configuration transmission 550 may include or indicate to use enhanced ESL notification coexistence operations or to adjust or implement a setting of a particular type of enhanced ESL notification coexistence operation. For example, the configuration transmission 550 may include ESL settings information 544.

During operation, devices of wireless communications system 500 perform enhanced notification coexistence operations. For example, the ESL network and wireless devices may exchange transmissions via uplink, downlink, and/or sidelink communications over the communication links and engage in enhanced ESL notification coexistence operations, as illustrated in the example of FIG. 5. Enhanced ESL notification coexistence operations enables improved flexibility and utilization of ESL notification resources, such as ESL notification output resources, and the ability to use both uplink and downlink based position determination operations. The enhanced ESL notification coexistence operations enable ESL devices to increase notification bandwidth and density, such as to output more notifications more clearly with a defined area.

In the example of FIG. 5, the ESL device 501 generates the configuration information for transmission in a configuration, timing, or notification configuration transmission, such as configuration information transmission 552. For example, the ESL device 501 may generate overall ESL timing related parameters and information for scheduling beacon transmissions, including for scheduling or performing DL and UL-based position determination operations. To illustrate, the ESL device 501 may generate timing/scheduling information relative to beacon start transmissions and/or energizing transmissions, such that the receiving devices can utilize this information along with received trigger transmissions to determine when to transmit. Additionally, or alternatively, the configuration information may include notification configuration information or notification coexistence information to configure notification parameters and/or notification requests. The configuration information may be transmitted in multiple ways. For example, the configuration information may be transmitted via a local wireless network or protocol (e.g., Wi-Fi or Bluetooth) to ESL devices and/or non-ESL devices, or may be transmitted via another network or protocol (e.g., cellular) to non-ESL devices. The configuration information may be part of or separate from the ESL settings information 544, and may configure or enable the devices to engage in enhanced notification coexistence operations.

As illustrated in the example of FIG. 5, the ESL device 501 transmits the configuration information transmission 552, including the configuration information, via wireless transmission to one or more ESL devices, one or more non-ESL devices, or a combination thereof. Examples of configuration information generation and transmission are described further with reference to FIGS. 6-10F, and may include an ESL AP, ESL controller, or a non-ESL device receiving ESL notification configuration information from the ESL server.

ESL devices of the network, such as the ESL device 501, periodically transmit beacons, such as described with reference to FIG. 3 to enable DL position determination, and/or the wireless device 503 may periodically transmit beacons or beacon responses to enable UL position determination. The beacons/responses may be used by ESL and non-ESL devices to determine a relative position for the ESL devices or a position within an ESL system, such as for DL or UL positioning estimation when the devices or ESL controllers/radio transmit the beacons, and the beacons are received by the wireless device 503. Additionally, the wireless device or eTags may transmit beacons which are measured by other ESL devices for use in UL positioning estimation.

In some aspects, the beacons transmitted by ESL devices and/or the wireless device 503 may be initiated by a beacon start transmission, as described with reference to FIG. 3. The beacon start transmission may be optionally sent by an ESL device, such as an ESL AP and the beacon start transmission may trigger beacons to be transmitted and monitored for by other devices according to or based on the configuration information, such as scheduling information thereof.

The positions determined by the ESL system and devices may be used by the ESL system to provide notifications to ESL and/or not ESL devices. For example, as the ESL system may have knowledge of the position of many ESL devices and non-ESL devices, the ESL system may provide position and/or direction information responsive to received requests. However, in ESL systems the ESLs themselves are often made up of many low-complexity devices and may be limited in terms of notification capability. For example, the ESLs may not have complex displays and/or the ESL controllers may not be capable of driving a multitude of unique notifications via the ESLs clearly and simultaneously.

In the aspects described herein, the ESL system may engage in enhanced notification coexistence operations to enable the ESL system to output an increased amount of notifications simultaneously to increase a notification bandwidth for ESL devices and/or non-ESL devices. For example, the ESL system may determine that two or more ESL notification requests overlap in a particular region. To illustrate, the ESL system determines that an area or first set of ESL devices/controllers associated with a first request overlaps with an area or second set of ESL devices/controllers associated with a second request. The ESL system may then engage notification coexistence operations to enable the system to output two or more notifications in close proximity clearly to two different users and to reduce the likelihood of notification confusion. Examples of determination of notification overlap and the generation of unique notifications are described further with reference to FIGS. 6-10F.

As illustrated in the example of FIG. 5, the ESL device 501 may receive a request transmission 554 indicating multiple notification request from one or more devices, such as wireless device 503. For example, the ESL device 501 may receive a notification request report from an ESL AP indicating multiple notification requests from multiple device users, including a first request from wireless device 503. In other aspects, the ESL device 501 may receive multiple request transmissions 554 each indicating one or more requests. For example, the ESL device may receive notification requests from multiple ESL APs or from multiple devices, each request indicate notification request information indicating a particular request. Each requests may be associated with a particular area directly, or indirectly, such as by indication of a particular ESL or asset, which itself is associated with a position/location.

After a determination to engage in enhanced notification coexistence operations, the ESL device 501 generates an ESL notification transmission 556 and transmits the ESL notification transmission 556 including the notification information 542 to one or more ESL devices, one or more non-ESL devices, or both. For example, the ESL device 501 may transmit the ESL notification transmission 556, including the notification information 542, to one or more ESL devices, such as one or more of ESL devices 591, to enable the ESL devices to output a notification (corresponding to the notification request of the request transmission 554) to other ESL and/or non-ESL devices (e.g., employees or shoppers) to indicate a position or provide directions to users thereof to guide them to the position. To illustrate, the notification information 542 may include ESL notification information which causes the ESL devices to output one or more notifications for one or more users of the ESL system. The notification information 542, such as the ESL notification information thereof, may include notification coexistence information to enable one or more ESL devices to output or adjust notifications to enable multiple different notifications to be provided in a particular area or region of the ESL system.

As another example, the ESL device 501 may transmit the notification information 542, such as device notification information, to one or more non-ESL devices to enable one or more of the non-ESL devices to output a notification to the user thereof to indicate a position or provide directions to the user thereof to guide them to the position. The notification corresponds to the notification request of the request transmission 554 and may be similar to or the same as the notification output by the one or more ESL devices 591, such as have the same or similar notification output parameters (e.g., notification type, subtype, period, duration, etc.) As illustrated in the example of FIG. 5, the ESL device 501 may transmit the notification information 542 to the wireless device 503 in a device notification transmission 558 to enable the wireless device 503 to output the notification to the user thereof. In some aspects, the device notification information enables or cause the wireless device 503 to synchronize its notification with the notification or notifications output by the ESL device or devices, such as one or more of ESL devices 591. To illustrate, the notification information may cause the device to output a similar notification type to the type of notification output by ESL devices or such that the notification outputs are synchronized in time, pitch, color, etc. As an illustrative example, the wireless device 503 may vibrate in a synchronized or a coordinated manner with the output from an ESL, such as in a similar manner to a flashing display or indicator of the ESL and/or with an audio output from an ESL.

Although one notification transmission is illustrated in the example of FIG. 5, the ESL device 501 may generate multiple notifications and/or notification transmissions for different devices and/or different regions to better utilize the notification capabilities of the ESL system an increase notification bandwidth. The increased notification bandwidth can be used to serve more notifications to more customers, and provide clear notifications in dense ESL networks.

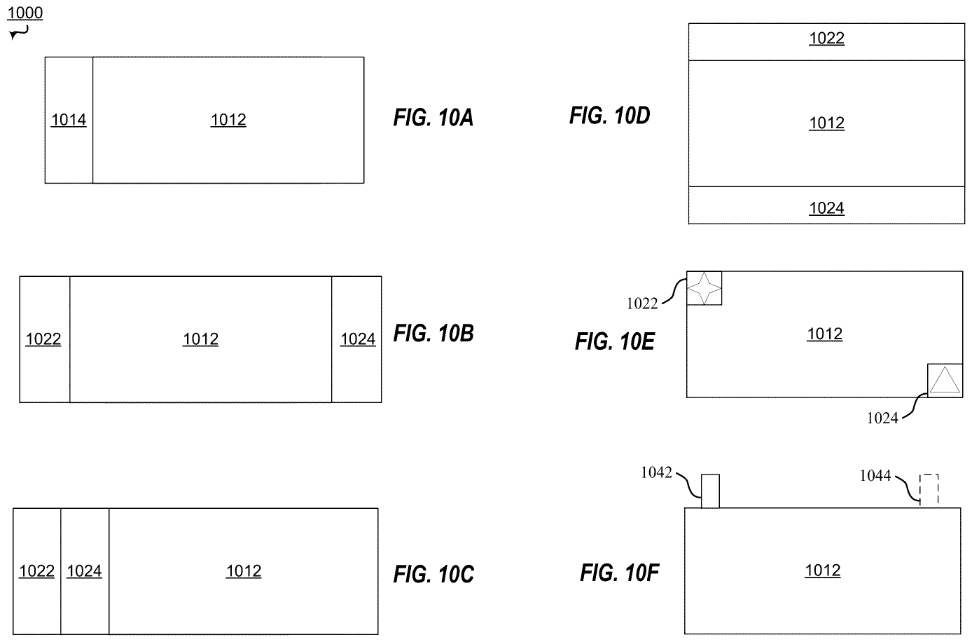

Additional examples of notification coexistence operations, including descriptions and examples for different notification coexistence signaling schemes and notification types, are described further with reference to FIGS. 6-10F. For example, generation of notifications, transmission of notifications, and illustrative examples of notifications are described further with reference to FIGS. 6-9 and different examples of visual notifications are described further with reference to FIGS. 10A-10F.

Accordingly, the network (e.g., the ESL device 501 and the wireless device 503) may be able to perform enhanced notification coexistence operations. Accordingly, the ESL network performance and ESL network and user experience may be increased due to enhanced ESL system capabilities based on enhanced notification capabilities.

Referring to FIG. 6, FIG. 6 is a timing diagram 600 illustrating an ESL system that supports notification coexistence operations according to one or more aspects. The example of FIG. 6 corresponds to an example of notification coexistence operations for a device interacting with the ESL system where notification requests and indication are transmitted via the ESL system The example of FIG. 6 may enable improved utilization of ESL notifications by enabling multiple overlapping notifications to be displayed clearly.

In the example of FIG. 6, the ESL system includes an ESL server 602, an ESL AP 604, ESL controllers 606, and devices 608 (e.g., non-ESL devices or UEs). Each of the ESL controllers 606 may include or correspond to an ESL with a wireless radio or a wireless device/radio associated with a plurality of ESLs.

Prior to 610, the ESL system may be configured with initial position information and/or configurations for network operation and positioning determination operations. For example, an operator may setup or preconfigure the system with initial positions for one or more devices and/or assets of the ESL systems. To illustrate, one or more of ESL APs, ESL controllers, ESLs, or assets (which may be tagged with an IoT tag) may be configured with an initial position. As another example, the ESL system may enter, such as upon initial setup, reconfiguration, or periodically (e.g., nightly weekly, monthly, quarterly, etc.), a measurement mode to determine initial or updated positions.

For example, the ESL server 602 may transmit configuration information (e.g., the configuration transmission 550 or the ESL settings information 546 of FIG. 5) to the ESL AP 604 and the ESL controllers 606. To illustrate, the ESL server 602 may transmit the configuration information directly to each device, such as by broadcast transmission or direct transmission, or the ESL server 602 may transmit the configuration information to ESL AP 604, which then transmits or relays then configuration information to one or more ESL devices, such as the ESL controllers 606. In an illustrative, non-limiting example, the ESL server 602 may transmit the configuration to ESL AP 604 via a wired connection, and the ESL AP 604 may unicast or broadcast the configuration information to the ESL devices and non-ESL devices.

As described above, the configuration information may include information configured to enable scheduling and timing coordination. For example, the configuration information may include UL and DL slot timing information for the difference devices or types/groups of devices.

Additionally, or alternatively, initial position information may be transmitted in the configuration information. For example, the operator may input a position into the ESL controllers 606, and the ESL controllers 606 may relay that position to the ESL server 602 via the ESL AP 604. As another example, the operator may configure the ESL server with the position of the ESL controllers 606, which is then relayed to the ESL controllers 606 via the ESL AP 604. As yet another example, each of the ESL controllers 606 determines its position based on a beacon of the ESL AP 604, and transmits its determined position to the ESL server 602.

At 610, the ESL server 602 may transmit notification configuration information to the devices 608 for participation in the ESL system. For example, the ESL server 602 may unicast or broadcast a transmission to one or more external devices, including the devices 608 (e.g., UEs), which indicates or includes ESL notification configuration information. The devices 608 may utilize the ESL notification configuration information to determine notification type information and/or how to transmit notification requests.

At 615, the ESL server 602 may transmit notification configuration information to the ESL AP 604 for relay to other ESL devices. For example, the ESL server 602 may unicast or broadcast a transmission to one or more ESL APs, including the ESL AP 604, which indicates or includes ESL notification configuration information. The ESL AP 604 may utilize the ESL notification configuration information to determine notification type information and/or how to relay notifications and/or notification requests.

At 620, the ESL AP 604 may transmit notification configuration information to one or more ESL controllers/devices, including the ESL controllers 606. For example, the ESL AP 604 may relay the notification configuration information or transmit ESL controller notification configuration information based on the received notification configuration information. The ESL AP 604 may transmit the notification configuration information by unicast or broadcast a transmission to the one or more ESL controllers/devices. The one or more ESL controllers/devices, including the ESL controllers 606 may utilize the ESL notification configuration information to determine how to display notifications.

At 625, a first device may transmit a first ESL notification request to the ESL server 602. For example, the first device may transmit a notification request transmission to the ESL server 602 via a cellular network or other network connection outside of the ESL system, which indicates or includes first ESL notification request information. The first ESL notification request information may be associated with a positioning or navigation request for a device or product associated with the ESL system. Additionally, or alternatively, the first ESL notification request information may be associated with a particular ESL display or displays of an ESL controller. In some aspects, the first ESL notification request information is associated with one or ESL displays of multiple ESL controllers.

As an illustrative example, an employee or shopper may use a cell phone or barcode scanner to submit a request for a particular product or location within a store. The ESL system may respond with a particular location for the employee or shopper. In order to guide the employee or shopper to the location and/or product, the ESL system may cause one or more ESLs of the system to display a notification to the employee or shopper to indicate the location and/or to guide them to the location. Contemporaneously in time with first request from the employee or shopper, a second person may submit a request to the ESL system for the same product or location or for a product or location that is proximate to the first product or location. In order to be able to clearly provide two outputs to the first and second users, the ESL system may generate the second notification based on the first notification. For example, the system may utilize a different visual indication or pattern, and can instruct the ESLs to display the two notifications at the same time or alternate between the two. The ESL system may also provide notification information to the two user devices to facilitate the notification. For example, the user devices may vibrate or chime in coordination with (e.g., synchronized with or similar to) the visual or other indications provided by the ESL.

In some aspects, such as when the notification is for directions or the requested location is far from the user location, the ESL system may utilize multiple ESLs, such as belonging to multiple controllers, to provide the notification to the user.

At 630, a second device may transmit a second ESL notification request to the ESL server 602. For example, the second device may transmit a second notification request transmission to the ESL server 602 via a cellular network or other network connection outside of the ESL system, which indicates or includes second ESL notification request information. The second ESL notification request information may be associated with a positioning or navigation request for a device or product associated with the ESL system. In some implementations, the device or product may be the same as or different from the product or device associated with the first ESL notification request information. The second ESL notification request information may be associated with a particular ESL display or displays of an ESL controller. In some aspects, the second ESL notification request information is associated with one or ESL displays of multiple ESL controllers.

In some implementations, the ESL display(s) and/or controller(s) may be the same as or different from the ESL display(s) and/or controller(s) associated with the first ESL notification request information. In the example of FIG. 6, the ESL display(s) and/or controller(s) associated with the first ESL notification request information are at least located in proximity to the ESL display(s) and/or controller(s) associated with the second ESL notification request information such that displaying a notification with similar outputs, visual audio, and/or haptic, for both devices would cause confusion.

At 635, the ESL server 602 may determine whether a proximity condition is satisfied for the received requests. For example, ESL server 602 may determine whether the received requests satisfy one or more proximity parameters. As illustrative, non-limiting examples, the proximity parameters may include one or more of a distance condition, an area condition, an ESL group condition, an aisle condition, or an aisle sub-condition (e.g., section and/or row of the aisle). To illustrate, the ESL server 602 may determine a distance between a first location associated with a first request and a second location associated with a second request, and may compare the distance difference to a distance or range threshold. The ESL server 602 may engage in notification coexistence operations when one or more conditions are met.

In some aspects, the ESL server 602 may utilize multiple conditions. For example, when using multiple conditions, the ESL server 602 may determine to engage in coexistence operations only when multiple conditions are satisfied, such as two or more or all conditions, or may determine to engage in coexistence operations when any condition of the multiple conditions is satisfied. As an illustrative example, when two or more requests are associated with a same aisle, portion of an aisle, ESL group, etc., the ESL server 602 may determine the proximity condition satisfied.

In some aspects, the ESL server 602 may determine whether the proximity condition is satisfied for the received requests based further on time, such as a time parameter. For example, the ESL server 602 may determine whether a time condition is satisfied prior to performance of the above proximity condition or conditions. To illustrate, the ESL server 602 may engage in a time determination prior to a proximity condition. The time parameter or condition may be in terms of a time value (e.g., milliseconds or slots) or in terms of bounding conditions or events, e.g., within the same beacon cycle or receive in the same notification report from an AP.

The location of the requesting devices may also be utilized in some aspects. For example, the locations of the requesting devices may be used to further determine if a proximity condition is satisfied, or when or for how long the proximity condition is satisfied. To illustrate, if one requesting device is near the jointly requested area or product and the other requesting device is far away, the ESL server 602 may determine no proximity condition overlap or that such indications will only overlap at a certain time or for a certain duration.

The location of the requesting devices, ESL devices, and products of the ESL system may be known to the ESL server 602. For example, the ESL server 602 may be pre-programmed or receive initial position information for one or more ESL devices, and the ESL server 602 may update those positions and determine positions for other devices based on UL and/or DL beacon positioning techniques as described above.

Additionally, or alternatively, the number of overlapping or proximate requests may used to determine an overlap condition and/or notification type. For example, if the number of concurrent notifications exceeds a notification type capability or amount of the ESL devices, the ESL server 602 may determine to alternate output or display of the notifications. As another example, if the number of overlapping or proximate requests is higher or larger, the notification generated by the ESL server 602 may be smaller and less likely to overlap. The ESL server 602 may use the amount of requests to adjust the proximity thresholds. For example, when over 10 requests are received within a time period and/or for a particular area, the ESL server may reduce the distance threshold for overlapping requests to reduce the chance of a proximity condition being satisfied.

Similarly, the user's location may be used to adjust the position or area of the request or the proximity conditions. For example, when the user is far away and desires guidance to the destination, the notification may overlap with notifications in multiple regions of the ESL system. The ESL server 602 may increase the area of overlap by increasing the distance threshold or may utilize multiple areas for the determination and use multiple evaluations or comparisons.

At 640, the ESL server 602 may determine notification indications based on the proximity determination at 635. For example, the ESL server 602 may determine notification indication parameters for one or more notification indications based on identifying two or more notifications/requests as overlapping. To illustrate, the ESL server 602 may determine notification indication parameters of notification type, notification subtype, notification duration, notification periodicity, or any combination thereof. As an illustrative, non-limiting example, the ESL server 602 may determine to output a visual indication of a flashing ESL screen for 30 seconds, with a flash periodicity of 0.5 seconds, and optionally with a flash duration of 0.25 seconds. As another illustrative, non-limiting example, the ESL server 602 may determine to output an audio indication of a particular chime sound for 12 seconds, with a periodicity of 3 seconds, and optionally with a chime duration of 0.75 seconds.

In some aspects, the notification generation may be done by a separate notification subsystem, and the ESL server 602 may include a notification adjust subsystem to adjust for overlapping conditions. For example, notifications of a single type may be displayed when one request is present and/or not overlapping, and then the server can generate or cycle through other types of notifications for subsequent notification determines as overlapping.

In some aspects, the ESL server 602 may use AI/ML techniques to determine the notifications, whether the notifications overlap, what notification(s) to display or generate, and/or how to adjust existing notifications. For example, the ESL server 602 may utilize a received model or may train a model based on historic notification data, historic notification overlap data, amount of ESLs, ESL density, historic ESL notification confusion, etc., or any combination thereof. The historic ESL notification confusion may include or correspond to repetitive requests by user for a same item or location and such repetitive requests may be indicative of notification confusion.

At 645, the ESL server 602 transmits first notification information to a first device. For example, the ESL server 602 may transmit a notification transmission, such as the ESL notification transmission 556 and/or the device notification transmission 558 of FIG. 5. To illustrate, the ESL server 602 may broadcast or unicast a transmission to a first device of the devices 608 that includes at least the first notification information for the first device. In the example of FIG. 6, the notification transmission is sent outside of the ESL system, such as via a cellular network connection or other network connection outside of the local ESL network connection (e.g., Wi-Fi or Bluetooth).

At 650, ESL server 602 transmits second notification information to a second device. For example, the ESL server 602 may transmit a second notification transmission, such as the ESL notification transmission 556 and/or the device notification transmission 558 of FIG. 5. To illustrate, the ESL server 602 may broadcast or unicast a transmission to a second device of the devices 608 that includes at least the second notification information for the second device. In the example of FIG. 6, the second notification transmission is sent outside of the ESL system, such as via a cellular network connection or other network connection outside of the local ESL network connection (e.g., Wi-Fi or Bluetooth).

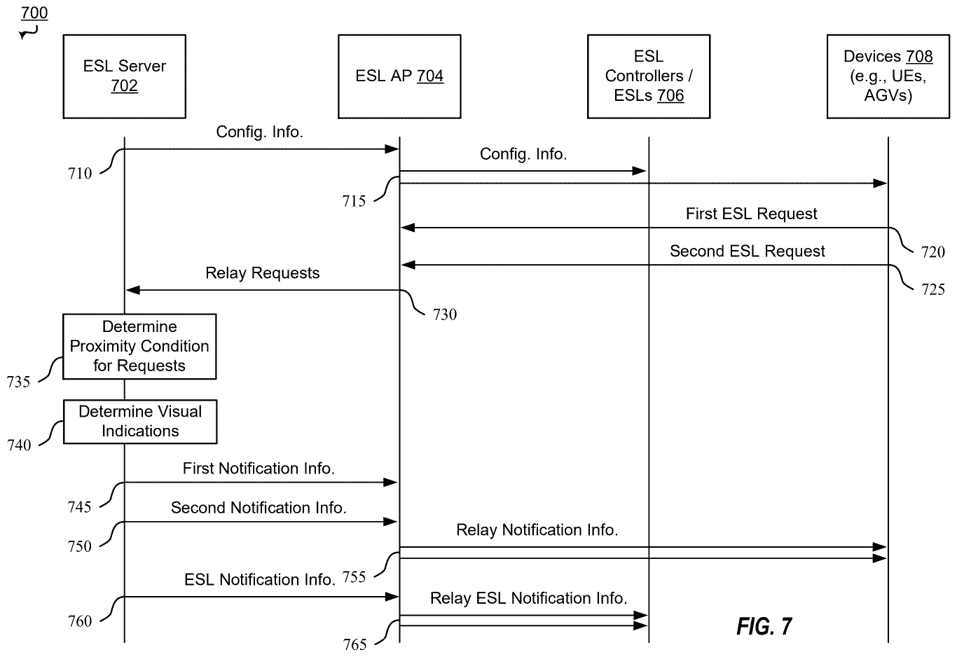

Although the first and second notification information are illustrated in different transmissions in the example of FIG. 6, such may be included in the same transmission in other examples. For example, in some implementations the notification transmissions sent by the ESL server 602, may include or indicate notifications (e.g., notification information) for multiple devices, including the first and second notification information. Alternatively, the notification transmission or transmissions may be sent via a local or ESL network connection (e.g., Wi-Fi or Bluetooth) in other implementations, as described further with reference to FIG. 7.

At 655, the ESL server 602 transmits ESL notification information to the ESL AP 604 for relay to other ESL devices. For example, the ESL server 602 may transmit an ESL notification transmission, such as the ESL notification transmission 556 of FIG. 5, to one or more ESL APs. To illustrate, the ESL server 602 may broadcast or unicast a transmission to a first ESL AP, ESL AP 604, that includes at least the first notification information for the first device. Additionally, or alternatively, the ESL server 602 may broadcast or unicast a transmission to the first ESL AP, ESL AP 604, or a second ESL AP that includes at least the second notification information for the second device. In some aspects, the ESL notification transmission may be a single transmission, with ESL notification information for multiple ESL devices and multiple ESL APs, as illustrated in the example of FIG. 6. In other aspects, the ESL server transmits multiple ESL notification transmissions in a wired or unicast manner to multiple ESL APs, such as a first ESL notification transmission to a first ESL AP, and a second ESL notification transmission to a second ESL AP. Even when multiple ESL notification transmissions are used, one or more of the ESL notification transmissions may include ESL notification information for multiple notifications, such as first ESL notification information for the first notification associated with the first device, and second ESL notification information for the second notification associated with the second device. A particular piece of ESL notification information may be relevant to multiple ESL controllers and ESL thereof, and in some aspects where the ESL controllers are associated with different ESL APs, the notification information for a particular notification may be sent to multiple ESL APs, for routing to multiple ESL controllers and corresponding ESLs thereof.

At 660, the ESL AP 604 may transmit the ESL notification information to one or more ESL controllers/devices, including the ESL controllers 606. For example, the ESL server 602 may unicast or broadcast an ESL notification transmission to one or more ESL APs, including the ESL AP 604, which indicates or includes the ESL notification information for one or more ESL notifications, and the ESL AP 604 then relays the ESL notification information to the one or more ESL controllers, such as by Wi-Fi or Bluetooth transmission. In some aspects, the ESL APs broadcast or groupcast the received ESL notification information to one or more groups or regions of devices based on the ESL notification information, such as based on a group identified by or associated with the ESL notification information. In other aspects, the ESL APs unicast the received ESL notification information to one or more specific devices based on the ESL notification information, such as based on a particular ESL controller or controllers identified by or associated with the ESL notification information.

After 660, one or more of the ESL controllers 606 output a notification based on the received ESL notification information. For example, one or more ESLs corresponding to a first ESL controller of the ESL controllers 606 may output notification based on the received ESL notification information or a portion thereof. In outputting the notification, the ESL controller(s) 606 may determine a type of the notification and parameters of the notification based on the ESL notification information, and may instruct the various ESL or ESLs to output the notification based on generating and providing commands to the ESL(s). In some aspects, the ESL controllers 606 may determine the type of notification based on additional information, such as ESL type information, ESL status information, current ESL notification information, etc., or a combination thereof. Examples of notifications output by ESLs are described further with reference to FIGS. 7-10F.

In some aspects, the ESL controllers 606 may determine whether the ESL notification information is applicable. For example, the ESL controllers 606 may determine whether any of the notifications indicated by the ESL notification information correspond to an ESL device associated with, such as coupled to or controlled by, the ESL controllers 606. To illustrate, when ESL notification information is broadcast or groupcast, the ESL controllers 606 may need to parse the ESL notification information to determine if any of the notifications thereof are relevant to ESLs thereof, including if any previous notifications need to be changed or stopped due to a proximity condition being satisfied (e.g., notifications overlapping).

In some aspects, the devices 608 may also output notifications based on the received notification information. For example, the devices 608 may output a visual, auditory, haptic, RF, or virtual indication that coincides with or is associated with the notification output by the ESL controllers 606. To illustrate, a particular shape, blinking pattern, color, tone, vibrating pattern, etc. may be output from a phone or smart watch of the devices 608. As another illustrate, a virtual indication may be displayed on an augmented reality display or an extended reality display of a device of the devices 608. As yet another example, a machine readable code, coded or structured light, or an RF indication may be provided to an AGV or robot from an ESL of the ESL controllers 606.

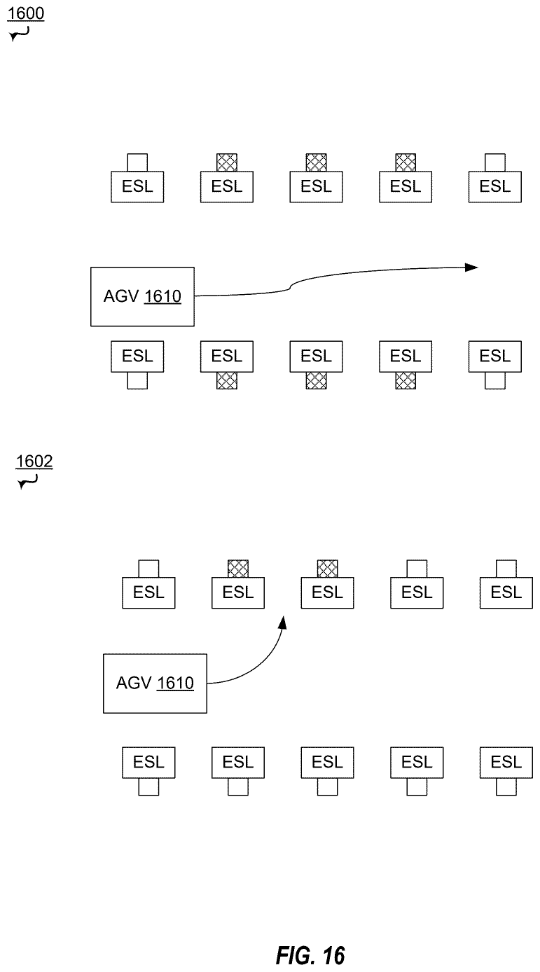

Additionally, or alternatively, the notification information provided to the ESL controllers 606 and/or the devices 608 may include or correspond to customized or specialized information for a particular user. To illustrate, the notification information may include special pricing information, and a special or adjusted price may be provided to and displayed or output via the device 608 which is different from an original or standard price displayed on the ESL of an ESL controller. In some such aspects, the specialized pricing may be associated with a user or user profile stored at the ESL server 602 or another server. To illustrate, the user or user profile may have grocery list, a shopping cart, or a stored list of favorited items or items to watch, and the system may generate specialty or dynamic pricing based on the information associated with the user or user profile to enable the ESL system to provide a series of notification (optionally including specialized or dynamic information) to one or more users. Such aspects are described further with reference to FIG. 16.

Referring to FIG. 7, FIG. 7 is a timing diagram 700 illustrating an ESL system that supports enhanced ESL notification coexistence operations according to one or more aspects. The example of FIG. 7 corresponds to an example of notification coexistence operations for a device interacting with the ESL system where notification requests and indication are transmitted via the ESL system.

In the example of FIG. 7, the ESL system includes an ESL server 702, an ESL AP 704, ESL controllers 706, and devices 708 (e.g., non-ESL devices or UEs). Each of the ESL controllers 706 may include or correspond to an ESL with a wireless radio or a wireless device/radio associated with a plurality of ESLs.

Prior to 710, the ESL system may be configured with initial position information and/or configurations for network operation and positioning determining operations. For example, an operator may setup or preconfigure the system with initial positions for one or more devices and/or assets of the ESL systems. To illustrate, one or more of ESL APs, ESL controllers, ESLs, or assets (which may be tagged with an IoT tag) may be configured with an initial position. As another example, the ESL system may enter, such as upon initial setup, reconfiguration, or periodically (e.g., nightly weekly, monthly, quarterly, etc.), a measurement mode to determine initial or updated positions.

For example, the ESL server 702 may transmit configuration information (e.g., the configuration transmission 550 or the ESL settings information 546 of FIG. 5) to the ESL AP 704 and the ESL controllers 706. To illustrate, the ESL server 702 may transmit the configuration information directly to each device, such as by broadcast transmission or direct transmission, or the ESL server 702 may transmit the configuration information to ESL AP 704, which then transmits or relays then configuration information to one or more ESL devices, such as the ESL controllers 706. In an illustrative, non-limiting example, the ESL server 702 may transmit the configuration to ESL AP 704 via a wired connection, and the ESL AP 704 may unicast or broadcast the configuration information to the ESL devices and non-ESL devices.

As described above, the configuration information may include information configured to enable scheduling and timing coordination. For example, the configuration information may include UL and DL slot timing information for the difference devices or types/groups of devices.

Additionally, or alternatively, initial position information may be transmitted in the configuration information. For example, the operator may input a position into the ESL controllers 706, and the ESL controllers 706 may relay that position to the ESL server 702 via the ESL AP 704. As another example, the operator may configure the ESL server 702 with the position of the ESL controllers 706, which is then relayed to the ESL controllers 706 via the ESL AP 704. As yet another example, each of the ESL controllers 706 determines its position based on a beacon of the ESL AP 704, and transmits its determined position to the ESL server 702.

At 710, the ESL server 702 may transmit notification configuration information to the ESL AP 704 for relay to other ESL devices and to non-ESL devices. For example, the ESL server 702 may unicast or broadcast a transmission to one or more ESL APs, including the ESL AP 704, which indicates or includes ESL notification configuration information. The ESL AP 704 may utilize the ESL notification configuration information to determine device notification configuration, ESL notification configuration, or both.

At 715, the ESL AP 704 may transmit notification configuration information to one or more ESL controllers/devices, including the ESL controllers 706, to one or more devices, including devices 708, or a combination thereof. For example, the ESL AP 704 may relay the notification configuration information or transmit ESL controller notification configuration information based on the received notification configuration information to the ESL controllers. Additionally, or alternatively, example, the ESL AP 704 may relay the notification configuration information or transmit device notification configuration information based on the received notification configuration information to the devices. The notification configuration information provided to the ESL controllers and the non-ESL devices may be transmitted in the same transmission or in different transmissions, such as BLE and Wi-Fi transmissions. In the alternative to the above where the ESL AP 704 provides the notification configuration information to the non-ESL devices directly, in other implementation the ESL AP provide the notification configuration information to the non-ESL devices via the ESL controllers 706.

The ESL AP 704 may transmit the notification configuration information by unicast or broadcast a transmission to one or more to one or more ESL controllers/devices. The one or more ESL controllers/devices, including the ESL controllers 706 and devices 708, may utilize the ESL notification configuration information to determine how to display notifications, how to request ESL notifications, and/or how to interpret ESL notifications.

At 720, a first device may transmit a first ESL notification request to the ESL server 702. For example, the first device may transmit a notification request transmission to an ESL AP, such as the ESL AP 704, for relay to the ESL server 702 via the ESL system, which indicates or includes first ESL notification request information. The first ESL notification request information may be associated with a positioning or navigation request for a device or product associated with the ESL system. Additionally, or alternatively, the first ESL notification request information may be associated with a particular ESL display or displays of an ESL controller. In some aspects, the first ESL notification request information is associated with one or ESL displays of multiple ESL controllers.

The first ESL notification request may include or correspond to the first ESL notification request sent at 625 of FIG. 6. As compared to FIG. 6, the device utilizes the ESL network to transmit the first ESL notification request to the ESL server 702 via the ESL AP 704 instead of using an outside network to transmit the first ESL notification request to the ESL server 602 and independent of other ESL devices.

At 725, a second device may transmit a second ESL notification request to the ESL server 702. For example, the second device may transmit a second notification request transmission an ESL AP, such as the ESL AP 704, for relay to the ESL server 702 via the ESL system, which indicates or includes second ESL notification request information. The second ESL notification request information may be associated with a positioning or navigation request for a device or product associated with the ESL system. In some implementations, the device or product may be the same as or different from the product or device associated with the first ESL notification request information. The second ESL notification request information may be associated with a particular ESL display or displays of an ESL controller. In some aspects, the second ESL notification request information is associated with one or ESL displays of multiple ESL controllers.

The second ESL notification request may include or correspond to the second ESL notification request sent at 630 of FIG. 6. As compared to FIG. 6, the device utilizes the ESL network to transmit the second ESL notification request to the ESL server 702 via the ESL AP 704 instead of using an outside network to transmit the second ESL notification request to the ESL server 602 and independent of other ESL devices.

In some implementations, the ESL display(s) and/or controller(s) may be the same as or different from the ESL display(s) and/or controller(s) associated with the first ESL notification request information. In the example of FIG. 7, the ESL display(s) and/or controller(s) associated with the first ESL notification request information are at least located in proximity to the ESL display(s) and/or controller(s) associated with the second ESL notification request information such that displaying a notification with similar outputs, visual audio, and/or haptic, for both devices would cause confusion.

At 730, the ESL AP 704 may relay the received notification requests to the ESL server for ESL notification operations. For example, the ESL AP 704 may receive ESL notification request transmissions from multiple devices and relay the ESL notification requests, or notification request information thereof, to the ESL server 702, such as by Wi-Fi or Bluetooth transmission. In some aspects, the ESL AP 704 may transmit both notification requests in a same transmission as illustrated in the example of FIG. 7. To illustrate, the ESL AP 704 may utilize a queue or buffer to store requests for relay to the ESL server, such as in an ESL notification request report. In other aspects, the ESL AP 704 may transmit the notification requests in a same transmission.

At 735, the ESL server 702 may determine whether a proximity condition is satisfied for the received requests. For example, ESL server 702 may determine whether the received requests satisfy one or more proximity parameters, similar to as described with reference to the determination of whether the received requests satisfy one or more proximity parameters described at 635 of FIG. 6.

At 740, the ESL server 702 may determine notification indications based on the proximity determination at 735. For example, the ESL server 702 may determine notification indication parameters for one or more notification indications based on identifying two or more notifications/requests as overlapping, similar to as described with reference to the determination of notification indications described at 640 of FIG. 6.

At 745, the ESL server 702 transmits first notification information to an ESL AP for relay to a first ESL device. For example, the ESL server 702 may transmit a first notification transmission, such as the ESL notification transmission 556 and/or the device notification transmission 558 of FIG. 5, to one or more ESL APs, including the ESL AP 704. To illustrate, the ESL server 702 may broadcast or unicast a transmission to one or more ESL APs via the ESL network that includes at least first notification information for the first device. In the example of FIG. 7, the first notification transmission is sent via the ESL system, such as via a wired ESL network connection or the local ESL network connection (e.g., Wi-Fi or Bluetooth).

At 750, ESL server 702 transmits second notification information to an ESL AP for relay to a second ESL device. For example, the ESL server 702 may transmit a second notification transmission, such as the ESL notification transmission 556 and/or the device notification transmission 558 of FIG. 5, to one or more second ESL APs, and optionally to the ESL AP 704. To illustrate, the ESL server 702 may broadcast or unicast a transmission to one or more ESL APs via the ESL network that includes at least second notification information for the second device. In the example of FIG. 7, the second notification transmission is sent via the ESL system, such as via a wired ESL network connection or the local ESL network connection (e.g., Wi-Fi or Bluetooth).

Although the first and second notification information are illustrated in different transmissions in the example of FIG. 7, such may be included in the same transmission in other examples. For example, in some implementations the notification transmissions sent by the ESL server 702, may include or indicate notifications (e.g., notification information) for multiple devices, including the first and second notification information. Alternatively, the notification transmission or transmissions may be sent outside of the local or ESL network connection (e.g., Wi-Fi or Bluetooth) in other implementations, as described with reference to FIG. 6.

At 755, the ESL AP 704 may relay the received notification transmissions to the devices for ESL notification operations. For example, the ESL AP 704 may receive notification transmissions for multiple devices from the ESL server 702 and may relay the notification transmissions, or notification information thereof, to one or more of the multiple devices, such as by Wi-Fi or Bluetooth transmission. In some aspects, the ESL AP 704 may transmit the notifications in different transmissions, as illustrated in the example of FIG. 7. In other aspects, the ESL AP 704 may transmit the notification transmissions in a same transmission. To illustrate, the ESL AP 704 may utilize a queue or buffer to store notification transmissions for relay to the devices, such as in an ESL notification report transmission.

At 760, the ESL server 702 transmits ESL notification information to the ESL AP 704 for relay to other ESL devices. For example, the ESL server 702 may transmit an ESL notification transmission, such as the ESL notification transmission 556 of FIG. 5, to one or more ESL APs. To illustrate, the ESL server 702 may broadcast or unicast a transmission to a first ESL AP, ESL AP 704, that includes at least the first notification information for the first device. Additionally, or alternatively, the ESL server 702 may broadcast or unicast a transmission to the first ESL AP, ESL AP 704, or a second ESL AP that includes at least the second notification information for the second device. In some aspects, the ESL notification transmission may be a single transmission, with ESL notification information for multiple ESL devices and multiple ESL APs, as illustrated in the example of FIG. 7. In other aspects, the ESL server 702 transmits multiple ESL notification transmissions in a wired or unicast manner to multiple ESL APs, such as a first ESL notification transmission to a first ESL AP, and a second ESL notification transmission to a second ESL AP. Even when multiple ESL notification transmissions are used, one or more of the ESL notification transmissions may include ESL notification information for multiple notifications, such as first ESL notification information for the first notification associated with the first device, and second ESL notification information for the second notification associated with the second device. A particular piece of ESL notification information may be relevant to multiple ESL controllers and ESL thereof, and in some aspects where the ESL controllers are associated with different ESL APs, the notification information for a particular notification may be sent to multiple ESL APs, for routing to multiple ESL controllers and corresponding ESLs thereof.

At 765, the ESL AP 704 may transmit the ESL notification information to one or more ESL controllers/devices, including the ESL controllers 706. For example, the ESL server 702 may unicast or broadcast one or more ESL notification transmission to one or more ESL APs, including the ESL AP 704, which indicates or includes the ESL notification information for one or more ESL notifications, and the ESL AP 704 then relays the ESL notification information to the one or more ESL controllers, such as by Wi-Fi or Bluetooth transmission. In some aspects, the ESL APs broadcast or groupcast the received ESL notification information to one or more groups or regions of devices based on the ESL notification information, such as based on a group identified by or associated with the ESL notification information. In other aspects, the ESL APs unicast the received ESL notification information to one or more specific devices based on the ESL notification information, such as based on a particular ESL controller or controllers identified by or associated with the ESL notification information.

Although the first and second notification information and the ESL notification information are illustrated in different transmissions in the example of FIG. 7, such notification and ESL notification information (e.g., information for notifying UEs of indications and information for causing ESLs to display notifications) may be included in the same transmission in other examples. For example, in some implementations a single notification report transmission sent by the ESL server 702, may include or indicate both notification information for one or more multiple devices and may include ESL notification for information for one or more multiple devices.

After 765, one or more of the ESL controllers 706 output a notification based on the received ESL notification information. For example, one or more ESLs corresponding to at least a first ESL controller of the ESL controllers 706 may output notification based on the received ESL notification information or a portion thereof. In outputting the notification, the ESL controllers 706 may determine a type of the notification and parameters of the notification based on the ESL notification information, and may instruct the various ESL or ESLs to output the notification based on generating and providing commands to the ESL(s). In some aspects, the ESL controllers 706 may determine the type of notification based on additional information, such as ESL type information, ESL status information, current ESL notification information, etc., or a combination thereof. Examples of notifications output by ESLs are described further with reference to FIGS. 7-10F.

In some aspects, the ESL controllers 706 may determine whether the ESL notification information is applicable. For example, the ESL controllers 706 may determine whether any of the notifications indicated by the ESL notification information correspond to an ESL device associated with, such as coupled to or controlled by, the ESL controllers 706. To illustrate, when ESL notification information is broadcast or groupcast, the ESL controllers 706 may need to parse the ESL notification information to determine if any of the notifications thereof are relevant to ESLs thereof, including if any previous notifications need to be changed or stopped due to a proximity condition being satisfied (e.g., notifications overlapping).

Referring to FIG. 8, FIG. 8 is a timing diagram 800 illustrating an example of an ESL system that supports enhanced notification coexistence operations according to one or more aspects. In the example of FIG. 8, the ESL system includes an ESL AP 802, one or more first ESL group devices 804, and one or more second ESL group devices 806. The ESL AP 802 may include or correspond to an ESL AP as described herein, such as ESL AP 604 of FIG. 6 or ESL AP 704 of FIG. 7. In other aspects, the ESL AP 802 may include or correspond to another device or multiple devices of the ESL system, such as the ESL server, ESL AP, or ESL controller/radio. The one or more first ESL group devices 804 may include or correspond to one or more first ESL controller/radios of the ESL system, and the one or more second ESL group devices 806 may include or correspond to one or more second ESL controller/radios of the ESL system. In some aspects, some of the first ESLs may also overlap with or be part of the second ESLs.

Prior to operation, and optionally periodically during operation, the ESL systems may determine and propagate initial configuration and/or position information to ESL and non-ESL devices and optional receive initial configuration and/or position information from the ESL and non-ESL devices, as described with reference to FIGS. 5-7.

At 810, the ESL AP 802 receives one or more notification transmissions. For example, the ESL AP 802 receives an ESL report with notification information for multiple ESLs from an ESL server, such as first notification information for a first notification, second notification information for a second notification. The notifications may correspond to notifications for UEs, such as ESL or non-ESL UEs in response to ESL notification requests from multiple UEs, and to be displayed at a particular ESL display or displays. Additionally, or alternatively, the ESL AP 802 may receive multiple ESL reports with one or more notifications or may receive ESL notifications in other messages. The transmission(s) may come from another ESL AP of the ESL system in some implementations, such as is relayed by one ESL AP to another ESL AP.

At 815, the ESL AP 802 determines one or more notifications based on the notification transmission(s). For example, the ESL AP 802 parses the received notification transmission or transmissions and determines one or more notifications indicated by notification information included therein.

In some aspects, the ESL AP 802 receives different notifications for different ESLs in close proximity to one another or for the same ESL. For example, the ESL server determines if two notifications satisfy a proximity condition (e.g., a notification overlap condition) and the network adjusts the notifications or determines at least one notification based on the other notification so as to have two or more notifications coexist clearly. In other aspects, the ESL AP 802 determines or modifies the notifications based on a proximity condition or conditions and/or an ESL device type.

At 820, the ESL AP 802 transmits notification transmissions to two or more ESL devices or groups. For example, the ESL AP 802 may relay the notifications received from the ESL server to their respective ESL controllers and ESL (e.g., displays). To illustrate, the ESL AP 802 may transmit a first ESL notification transmission or transmissions to the first ESL group devices 804 and may transmit a second ESL notification transmission or transmissions to the second ESL group devices 806. In some aspects the first and second ESL notification transmissions are the same transmission, and in others, the first and second ESL notification transmissions are different transmissions. When the first and second ESL notification transmissions are different transmissions, the transmissions may be sent at the same time or may be sent at different times (e.g., sequentially). Additionally, or alternatively, when the first and second ESL notification transmissions are different transmissions, the transmissions may have the same notification data (e.g., notification data indicating two different notifications) or different notification data (e.g., first notification data for the first ESL notification transmission and second notification data for the second notification transmission).

At 825, the first ESL group devices 804 output one or more first notifications. For example, at least one ESL display/ESL of an ESL controller of the first ESL group devices 804 outputs a notification. To illustrate, multiple ESLs/ESL displays of the ESL controllers of the first ESL group devices 804 each output a unique notification. The notifications may have different combinations of audio, visuals, or haptic outputs, and some exemplary visual notifications/outputs are described further with reference to FIGS. 10A-10F.

At 830, the second ESL group devices 806 output one or more second notifications. For example, at least one ESL display/ESL of an ESL controller of the second ESL group devices 806 outputs a second notification that is different from the first notification output by the first ESL group devices 804. To illustrate, multiple second ESLs/ESL displays of the ESL controllers of the second ESL group devices 806 each output a unique notification. The notifications may have different combinations of audio, visuals, or haptic outputs, and some exemplary visual notifications/outputs are described further with reference to FIGS. 10A-10F.

After 830 and prior to 835, the ESL AP 802 may optionally receive additional notification transmissions, similar to the notification transmissions received at 810. Additionally, the ESL AP 802 may optionally determine one or more notifications based on the notification transmission(s), similar to the determination(s) at 815.

At 835, the ESL AP 802 transmits notification transmissions to one or more ESL devices or groups. For example, the ESL AP 802 may relay the notifications received from the ESL server to their respective ESL controllers and ESL (e.g., displays). To illustrate, the ESL AP 802 may transmit a third ESL notification transmission or transmissions to the first ESL group devices 804. In other implementation, the ESL AP 802 may also transmit the third (or fourth) ESL notification transmission or transmissions to the second ESL group devices 806.

At 840, the first ESL group devices 804 output one or more third notifications. For example, at least one ESL display/ESL of an ESL controller of the first ESL group devices 804 outputs a notification. To illustrate, multiple ESLs/ESL displays of the ESL controllers of the first ESL group devices 804 each output a unique notification. The notifications may have different combinations of audio, visuals, or haptic outputs, and some exemplary visual notifications/outputs are described further with reference to FIGS. 10A-10F.

After 840 and prior to 845, the ESL AP 802 may optionally receive additional notification transmissions, similar to the notification transmissions received at 810. Additionally, the ESL AP 802 may optionally determine one or more notifications based on the notification transmission(s), similar to the determination(s) at 815.

At 845, the ESL AP 802 transmits notification transmissions to one or more ESL devices or groups. For example, the ESL AP 802 may relay the notifications received from the ESL server to their respective ESL controllers and ESL (e.g., displays). To illustrate, the ESL AP 802 may transmit a fourth ESL notification transmission or transmissions to the second ESL group devices 806. In other implementation, the ESL AP 802 may also transmit the fourth (or a fifth) ESL notification transmission or transmissions to the first ESL group devices 804.

At 850, the second ESL group devices 806 output one or more fourth notifications. For example, at least one ESL display/ESL of an ESL controller of the second ESL group devices 806 outputs a fourth notification that is different from the third notification output by the first ESL group devices 804. To illustrate, multiple second ESLs/ESL displays of the ESL controllers of the second ESL group devices 806 each output a unique notification. The notifications may have different combinations of audio, visuals, or haptic outputs, and some exemplary visual notifications/outputs are described further with reference to FIGS. 10A-10F. Although two sets/groups of ESL devices and a single ESL AP is illustrated in FIG. 8, the ESL system may include one or more additional ESL APs, one or more additional ESL groups, or both in other aspects.

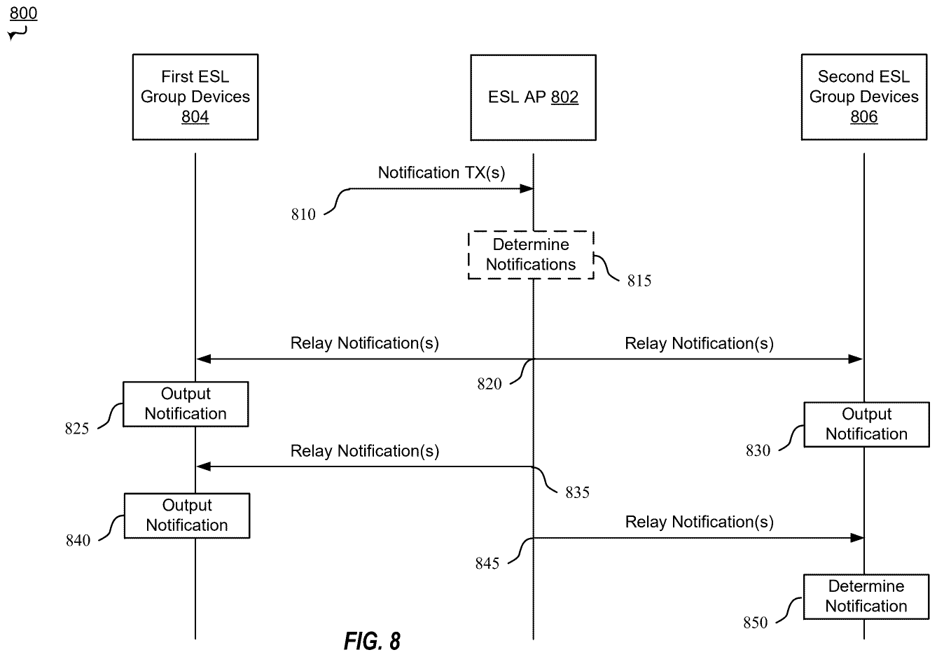

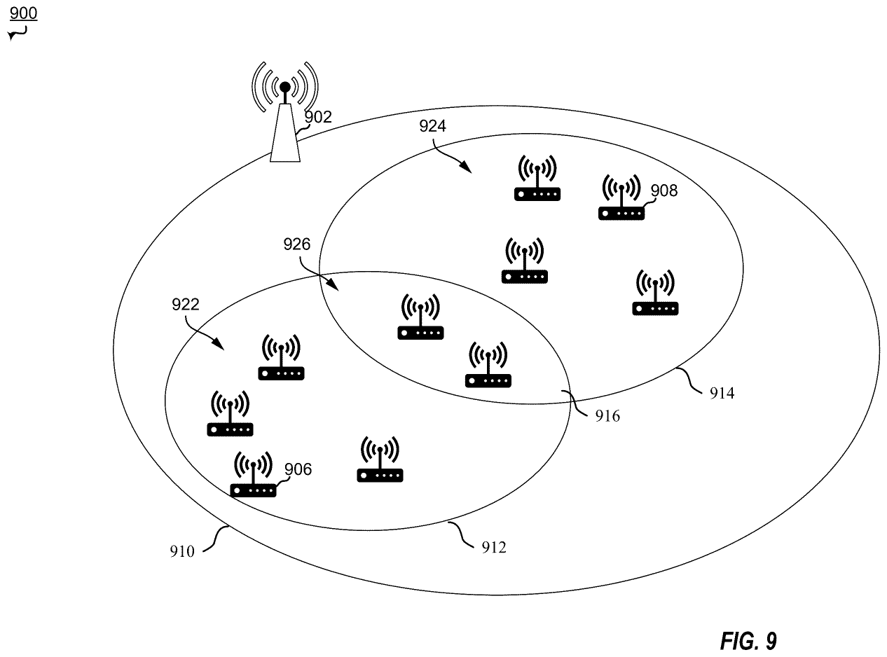

Referring to FIG. 9, diagram 900 illustrates a diagram of an example of ESL system according to one or more aspects of the disclosure. As depicted by diagram 900, the example of ESL system may include a coverage area 910 served by an ESL AP 902. The coverage area may include multiple ESL controller/radios which may be divided or partitioned into groups. For example, as illustrated in FIG. 9, the coverage area includes a first area 912 (e.g., notification coverage area or notification range) associated with a particular notification or ESL (e.g., ESL 906) and a second area 914 (e.g., notification coverage area or notification range) associated with a particular notification or ESL (e.g., ESL 908). These areas 912 and 914 may each be associated with, within range of, and/or served by multiple ESL controllers/radios of a plurality of ESL controllers/radios, collectively ESL controllers 904, as shown in FIG. 9. As illustrated in the example of FIG. 9, the areas 912 and 914 may overlap with each other, as shown by the overlap area 916. Accordingly, some of the first ESL controllers 922 associated with the particular notification or ESL 906 may also be associated with the particular notification or ESL 908, i.e., part of the second ESL controllers 924 associated with the ESL 908. To illustrate, third ESL controllers 926 in the overlap area 916 are part of the first ESL controllers 922 and the second ESL controllers 924. FIG. 9 illustrates a simplified example of an ESL system; the ESL system may include multiple ESL APs and multiple AP coverage areas within an ESL system coverage area. Additionally, these AP coverage areas might overlap with each other.

The devices of FIG. 9 may include or correspond to one or more devices of the previous figures. For example, the ESL AP 902 may include or correspond to the ESL device 501 or ESL AP 802 of FIGS. 5 and 8 or an ESL AP as in FIGS. 6 and 7. The ESL controller/radios may include or correspond to the ESL device 501 or ESL Group Devices 804 or 806 of FIGS. 5 and 8 or an ESL controller as in FIGS. 6 and 7. An eTag may include or correspond to the eTags 593 of FIG. 5. A UE may include or correspond to the wireless device 503 of FIG. 5, or a device of the devices 608 of FIG. 6, the devices 708 of FIG. 7, or the ESL group devices 804 or 806 of FIG. 8.

In some aspects, two or more ESL controllers (e.g., an ESL radio or multiple ESL radios associated therewith) of the ESL system may be grouped together to create groups for enhanced notification coexistence. For example, as some ESL system may be large, the notifications output by the ESL system may be local to a particular area and group of devices. The ESL system may partition the devices into groups, based on area, device density, device type, device association, etc., or a combination thereof, using known position information of the ESL devices, the eTags, and/or the non-ESL devices. Using ESL groups may further enhance the improvements of notifications coexistence by enabling multiple difference notifications or notifications adjustments simultaneous and/or enabling notifications for one area and not another.

To illustrate, based on a currently known position estimate or setup configuration/information, a first subset of ESL controllers/radios may be identified by the ESL system to display a first type of notification. As an example, the subset may be in the vicinity (e.g., within 2 meters, as an illustrative, non-limiting example) of a location or one or more eTags or ESLs requested by a UE. Similarly, the ESL system may identify a second subset of ESL controllers/radios to display a second type of notification during the particular time period.

In some such aspects that involve ESL device grouping, there may be a time period or event where the first notification and the second notification are in the same vicinity, as illustrated in the example of FIG. 9. In such situations, this may cause groups of ESL device to output notifications near one another and/or have one or more ESL scheduled to output two or more notifications. For example, some ESL controllers/radios that are part of a first subset of ESL controllers/radios which are associated with the first eTag/first notification, may also a be part of a second subset of ESL controllers/radios that are associated with the second eTag/second notification. These overlapping notifications may be configured to be output at the same time by the same or nearby ESL devices using one or more of the notification schemes and notifications described above and further described with reference to FIGS. 10A-10F.

The ESL system may modify ESL groups, such as by modifying the groups and/or by partitioning the groups or making subgroups/subsets, to manage the notifications in a particular area to enable multiple unique notifications to be displayed and differentiated from one another locally across the coverage area. To illustrate, in the above example the ESL system may determine a third group of ESL controllers/radios may be used in place of the first group of ESL controllers/radios that were originally associated with the first request (e.g., a particular eTag or ESL). The third group of ESL controllers/radios may include or correspond to a subset of the first group that is created by removing the overlapping ESLs in the first group, that is the ESLs that are part of the first group and part of the second group. To illustrate, third ESL controllers 926 within the overlap area 916 that overlaps with/are part of two ESL groups may be removed from the first ESL controllers 922 to create a third group. To determine alternative ESL groups and/or to determine when or how to modify the ESL groups, the ESL system may use one or more parameters, such as location, overlap with the second group or groups, type of ESL, type of notifications displayable by the ESL, battery threshold, estimated remaining battery life, amount of associated groups/devices, etc., or a combination thereof.

Although the example above was described for creating an alternative group or subset (the third subset) for the first group, in other examples and additional or alternative group (e.g., a fourth group) may instead be used in place of the second group for the mobile device. The fourth group may include or correspond to a subset of devices of the second group. The grouping process (e.g., grouping and adjusting/regrouping) may be repeated iteratively as notifications change, and/or as eTags and devices move through the ESL coverage area. The groups of devices may then be used by the ESL to determine if a proximity condition is satisfied, to determine what types of notifications can be displayed, to display a particular ESL notification, or any combination thereof.

In some implementations, the ESL system may have multiple devices that are awaiting a notification. For example, the ESL system may determine multiple devices are requesting a notification for a particular area, and the ESL system may generate a subset of the notifications based on the priority. For example, the ESL system may identify a particular set of requests based on a priority associated with a location of the device.

As an example of the priority determination, the devices may be ranked using one or more parameters, such as device type, time since last request, time since last position determination, distance to request, etc., or a combination thereof. For example, a device with a lower distance to a request area may be given higher priority for notification output and/or a device associated with a store employee may be assigned a higher or lower priority for scheduling than a customer depending on store operations or parameters. In some such aspects, the devices with a higher priority value or rank, may be scheduled for notifications first, and devices in lower priority values may be scheduled in later, and in some cases only after the notifications for the higher priority devices have ceased.

FIGS. 10A-10F each illustrate an example visual notification for an ESL system that supports enhanced notification coexistence operations according to one or more aspects. In FIGS. 10A-10F illustrative examples of visual notifications are illustrated. Referring to FIG. 10A, an example of an ESL displaying a single indication is provided. In the example of FIG. 10A, the ESL display includes a product information section 1012 and a visual notification section 1014. The product information section 1012 may be configured to display product information, such as name, brand, price, weight, etc., and the visual notification section 1014 may be configured to output a visual indication corresponding to one or more ESL notifications. For example, the visual notification section 1014 may be configured to output a particular color, to flash, to output a particular design, or any combination thereof. The visual notification section 1014 may be configured to output multiple notifications at once based on one or more parameters, such as by displaying a particular logo and flashing a particular color. In some aspects, the product information section 1012 may also be configured to output an ESL notification, such as by flashing and/or displaying the product information in a particular manner or color.

As illustrative examples for a visual notification section 1014, the visual notification section 1014 may display a slow flashing green light, a rapidly flashing blue light, or a flashing red triangle with a white background. Other examples and combinations can be made with different, symbols, colors, and flashing patterns. The indications may be indicated by a bitmap, such as where 00000 indicates a first visual pattern, 00001 indicates a second visual pattern, and so on.

Referring to FIG. 10B, an example of an ESL displaying multiple indications is provided. In the example of FIG. 10B, the ESL display includes a product information section 1012, a first visual notification section 1022 and a second visual notification section 1024. The first visual notification section 1022 and the second visual notification section 1024 may include or correspond to the visual notification section 1014 of FIG. 10A, and may each be configured to output a visual indication corresponding to an ESL notification. For example, the first visual notification section 1022 may be configured to output a particular color, to flash, to output a particular design, or any combination thereof, to output a first notification, and the second visual notification section 1024 may be configured to output a second particular color, to flash with a second, different pattern, to output a second particular design, or any combination thereof, to output a second notification. The visual notification sections 1022 and 1024 may each be configured to output multiple notifications at once based on one or more parameters, such as by displaying a particular logo and flashing a particular color.

Referring to FIG. 10C, another example of an ESL displaying multiple indications is provided. In the example of FIG. 10C, the ESL display includes a product information section 1012, a first visual notification section 1022 and a second visual notification section 1024. As compared to the example of FIG. 10B, which has the first visual notification section 1022 and the second visual notification section 1024 arranged on opposite sides (e.g., opposite side and arranged vertically), the first visual notification section 1022 and the second visual notification section 1024 are on the same side in the example of FIG. 10C.

Referring to FIG. 10D, another example of an ESL displaying multiple indications is provided. In the example of FIG. 10D, the ESL display includes a product information section 1012, a first visual notification section 1022 and a second visual notification section 1024. As compared to the previous examples of FIGS. 10A-10C which have the visual notification section(s) arranged vertically, the first visual notification section 1022 and the second visual notification section 1024 are arranged horizontally (e.g., on the top and bottom) in the example of FIG. 10D.

Referring to FIG. 10E, another example of an ESL displaying multiple indications is provided. In the example of FIG. 10E, the ESL display includes a product information section 1012, a first visual notification section 1022 and a second visual notification section 1024. As compared to the previous examples of FIGS. 10A-10D which have the visual notification section(s) arranged along an entire side, the first visual notification section 1022 and the second visual notification section 1024 correspond to a portion of a side in the example of FIG. 10E and are configured to display a design or logo. Specifically, the first visual notification section 1022 and the second visual notification section 1024 are located in opposite corners and can display shapes in addition to or in the alternative of displaying a color.

Referring to FIG. 10F, an example of an ESL including one or more LEDs capable of displaying an ESL notification is provided. In the example of FIG. 10F, the ESL includes one or more LEDs, including at least a first LED 1042. The ESL may optionally include one or more other LEDs, such as a second LED 1044. Each LED may be configured to output one or more visual indications. For example, a green blinking LED may indicate one notification by the green color and another notification by blinking or blinking with a particular pattern or period.

Although multiple visual indication examples are described above, the ESL notifications output by an ESL system as described herein may include other types of notifications in addition to or in the alternative of the visual indications. Additionally, or alternatively, the ESL notifications output by an ESL system may include or correspond to combinations of one or more indications or ESL as described with reference to FIGS. 10A-10F. For example, an ESL may include one or more LEDs as in FIG. 10F and may include one or more visual notification sections as in any of FIGS. 10A-10F. As another example, an ESL may utilize one or more additional modalities, such as audio, haptic, RF, etc., to indicate a notification or notifications from an ESL device or devices.

Although the examples of FIGS. 10A-10F are directed to examples directed to human users, the notifications displayed may be customized for machines. For example, the visual notifications may include machine readable codes (e.g., barcodes, QR codes, etc.), structured or coded light (e.g., light patterns), blinking or flashing lights, RF signals, audio tones, etc., and the code may be able to guide a machine around the ESL area (e.g., warehouse, storage area, retail store, etc.). An example of this is further described with reference to FIG. 16.

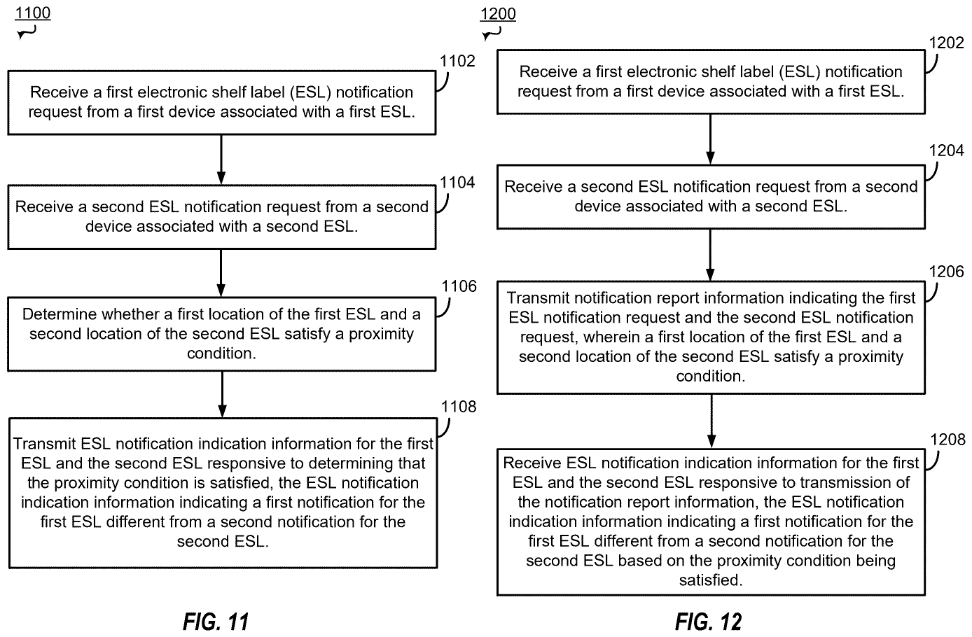

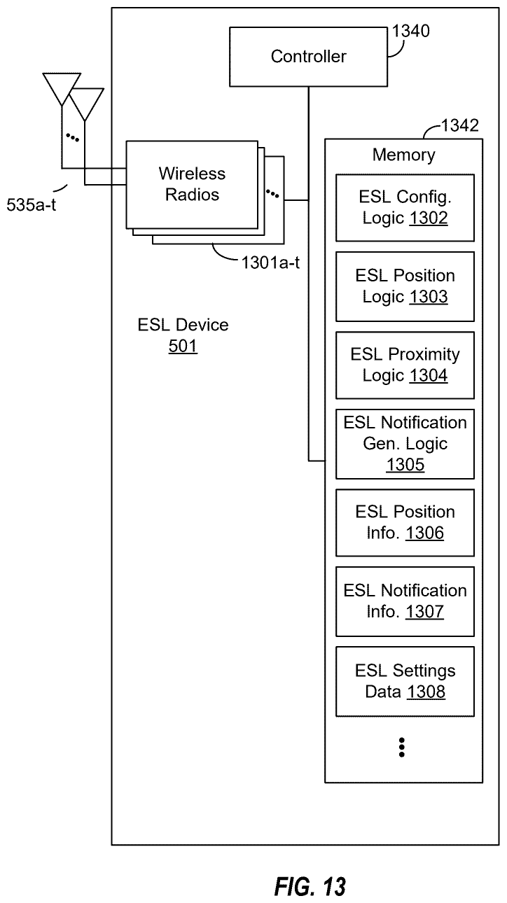

FIG. 11 is a flow diagram 1100 illustrating example blocks executed by wireless communication device (e.g., an ESL device or a UE) configured according to an aspect of the present disclosure. The example blocks will also be described with respect to ESL device 501 as illustrated in FIG. 13. FIG. 13 is a block diagram illustrating ESL device 501 configured according to one aspect of the present disclosure. ESL device 501 includes the structure, hardware, and components as illustrated for ESL device 501 of any of FIG. 5. For example, ESL device 501 includes controller/processor 1340, which operates to execute logic or computer instructions stored in memory 1342, as well as controlling the components of ESL device 501 that provide the features and functionality of ESL device 501. ESL device 501, under control of controller/processor 240, transmits and receives signals via wireless radios 1301a-t and antennas 535a-t. As illustrated in the example of FIG. 13, memory 1342 stores one or more of ESL configuration logic 1302, ESL position logic 1303, ESL proximity logic 1304, ESL notification generation logic 1305, ESL position information 1306, ESL notification information 1307, or ESL settings data 1308. The data (1302-1308) stored in the memory 242 may include or correspond to data and/or logic to enable the operations of FIGS. 5-16.

At block 1102, a wireless communication device, such as an ESL device (e.g., an ESL server), receives a first electronic shelf label (ESL) notification request from a first device associated with a first ESL. The first ESL notification request may include or correspond to request information 506 or a request transmission, such as the request transmission 554 of FIG. 5, the first ESL or second ESL request transmitted at 625 or 630 of FIG. 6 or 720 or 725 of FIG. 7, or the ESL report or relay at 730 of FIG. 7. The first device may include or correspond to any of the devices which may request an ESL position based notification as described in any of FIGS. 5-16, such as a non-ESL device or UE. The first ESL may include or correspond to any of the ESLs associated with and/or controlled by an ESL device or controller as described in any of FIGS. 5-16, such as an ESL controller/radio. For example, the ESL device 501 receives the request transmission 554, including the request information 506 for an ESL based notification. As another example, the ESL server 602 receives the first or second ESL requests of FIG. 6. As yet another example, the ESL AP 704 receives the first or second ESL requests of FIG. 7. Other examples are also described in FIGS. 6-16.

At block 1104, the wireless communication device receives a second ESL notification request from a second device associated with a second ESL. The second ESL notification request may include or correspond to request information 506 or a request transmission, such as the request transmission 554 of FIG. 5, the first ESL or second ESL request transmitted at 625 or 630 of FIG. 6 or 720 or 725 of FIG. 7, or the ESL report or relay at 730 of FIG. 7. The second device may include or correspond to any of the devices which may request an ESL position based notification as described in any of FIGS. 5-16, such as a non-ESL device or UE. The second ESL may include or correspond to any of the ESLs associated with and/or controlled by an ESL device or controller as described in any of FIGS. 5-16, such as an ESL controller/radio. For example, the ESL device 501 receives the request transmission 554, including the request information 506 for an ESL based notification. As another example, the ESL server 602 receives the first or second ESL requests of FIG. 6. As yet another example, the ESL AP 704 receives the first or second ESL requests of FIG. 7. Other examples are also described in FIGS. 6-16.

At block 1106, the wireless communication device determines whether a first location of the first ESL and a second location of the second ESL satisfy a proximity condition. The first location may include or correspond to a position or location of an ESL device, such as an ESL controller or ESL, that is associated with a request from a first UE and indicated by position information 508. The second location may include or correspond to a position or location of the ESL device or a second ESL device, such as another ESL controller or another ESL, that is associated with a second request from a second UE and indicated by position information 508. For example, the ESL device 501 determines a location of or associated with each request of a request report or of multiple request transmissions 554 and determines if the locations satisfy a notification proximity threshold. Other examples are also described in FIGS. 6-16.

At block 1108, the wireless communication device transmits ESL notification indication information for the first ESL and the second ESL responsive to determining that the proximity condition is satisfied, the ESL notification indication information indicating a first notification for the first ESL different from a second notification for the second ESL. The ESL notification indication information may include or correspond to the notification information 542 of FIG. 5 and/or the notification transmissions 556 or 558 of FIG. 5, the first or second notification information of FIG. 6 or 7, the ESL notification information of FIG. 6 or 7, or the relay notifications of FIG. 8. The first notification for the first ESL different from a second notification for the second ESL may include or correspond any of the notifications described with reference to FIGS. 4-16, such as audio notifications, visual notifications, haptic notifications, or any combination thereof. For example, the ESL device 501 transmits the ESL notification transmission 556 with ESL notification information (e.g., notification information 542) to one or more ESL devices of the ESL device 591 or the ESL device 501 transmits the device notification transmission 558 with device notification information (e.g., notification information 542) to one or more non-ESL devices, sch as the wireless device 503. As another example, an ESL server or AP, such as ESL server 602, 702, ESL AP 604, 704, or ESL AP 802, transmits ESL notification information to one or more ESL devices or transmits device notification information to one or more non-ESL devices. Other examples are also described in FIGS. 6-16.

The wireless communication device (e.g., UE or ESL device) may execute additional blocks (or the wireless communication device may be configured further to perform additional operations) in other implementations. For example, the wireless communication device, such as one or more processors and one or more memories (e.g., a processing system) thereof, may perform one or more operations described above, such as described with reference to FIGS. 5-16 or as described below. As another example, the wireless communication device may perform one or more aspects as presented below.

Accordingly, wireless communication devices may perform enhanced notification coexistence operations to dynamically and flexibly leverage ESL notification resources to output position or location based operations, such as to output multiple notifications concurrently in close proximity to one another. In some aspects, the wireless communication devices may utilize proximity based thresholds to determine when to perform the notification coexistence operations. Additionally, notification information may be provided to the devices to enable notification synching by the devices with the notifications output by the ESLs. Accordingly, the network performance and user experience may be increased due to increased notification bandwidth and clarity.

FIG. 12 is a flow diagram 1200 illustrating example blocks executed by wireless communication device (e.g., a UE or an ESL device) configured according to an aspect of the present disclosure. The example blocks of FIG. 12 will also be described with respect to ESL device 501 as illustrated in FIG. 13. The example blocks of FIG. 12 may be practiced by any of the ESL devices described herein.

At block 1202, a wireless communication device, such as an ESL device (e.g., ESL AP), receives a first electronic shelf label (ESL) notification request from a first device associated with a first ESL. The first ESL notification request may include or correspond to request information 506 or a request transmission, such as the request transmission 554 of FIG. 5, the first ESL or second ESL request transmitted at 625 or 630 of FIG. 6 or 720 or 725 of FIG. 7, or the ESL report or relay at 730 of FIG. 7. The first device may include or correspond to any of the devices which may request an ESL position based notification as described in any of FIGS. 5-16, such as a non-ESL device or UE. The first ESL may include or correspond to any of the ESLs associated with and/or controlled by an ESL device or controller as described in any of FIGS. 5-16, such as an ESL controller/radio. For example, the ESL device 501 receives the request transmission 554, including the request information 506 for an ESL based notification. As another example, the ESL server 602 receives the first or second ESL requests of FIG. 6. As yet another example, the ESL AP 704 receives the first or second ESL requests of FIG. 7. Other examples are also described in FIGS. 6-16.

At block 1204, the wireless communication device receives a second ESL notification request from a second device associated with a second ESL. The second ESL notification request may include or correspond to request information 506 or a request transmission, such as the request transmission 554 of FIG. 5, the first ESL or second ESL request transmitted at 625 or 630 of FIG. 6 or 720 or 725 of FIG. 7, or the ESL report or relay at 730 of FIG. 7. The second device may include or correspond to any of the devices which may request an ESL position based notification as described in any of FIGS. 5-16, such as a non-ESL device or UE. The second ESL may include or correspond to any of the ESLs associated with and/or controlled by an ESL device or controller as described in any of FIGS. 5-16, such as an ESL controller/radio. For example, the ESL device 501 receives the request transmission 554, including the request information 506 for an ESL based notification. As another example, the ESL server 602 receives the first or second ESL requests of FIG. 6. As yet another example, the ESL AP 704 receives the first or second ESL requests of FIG. 7. Other examples are also described in FIGS. 6-16.

At block 1206, the wireless communication device transmits notification report information indicating the first ESL notification request and the second ESL notification request, wherein a first location of the first ESL and a second location of the second ESL satisfy a proximity condition. The notification report information may include or correspond to the request information 506 from multiple non-ESL devices in the request transmission(s) 554 of FIG. 5, the first ESL and second ESL requests transmitted at 625 or 630 of FIG. 6 or 720 or 725 of FIG. 7, or the ESL report or relay at 730 of FIG. 7. The first location may include or correspond to a position or location of an ESL device, such as an ESL controller or ESL, that is associated with a request from a first UE and indicated by position information 508. The second location may include or correspond to a position or location of the ESL device or a second ESL device, such as another ESL controller or another ESL, that is associated with a second request from a second UE and indicated by position information 508. For example, an ESL AP, such as ESL AP 604, 704, or ESL AP 802, relays ESL or notification requests to an ESL server 702 at 730 of FIG. 7, where the ESL or notification requests are received from non-ESL devices, such as devices 708. Other examples are also described in FIGS. 6-16.

At block 1208, the wireless communication device receives ESL notification indication information for the first ESL and the second ESL responsive to transmission of the notification report information, the ESL notification indication information indicating a first notification for the first ESL different from a second notification for the second ESL based on the proximity condition being satisfied. The ESL notification indication information may include or correspond to the notification information 542 of FIG. 5 and/or the notification transmissions 556 or 558 of FIG. 5, the first or second notification information of FIG. 6 or 7, the ESL notification information of FIG. 6 or 7, or the relay notifications of FIG. 8. The first notification for the first ESL different from a second notification for the second ESL may include or correspond any of the notifications described with reference to FIGS. 4-16, such as audio notifications, visual notifications, haptic notifications, or any combination thereof. For example, the ESL device 501 transmits the ESL notification transmission 556 with ESL notification information (e.g., notification information 542) to one or more ESL devices of the ESL device 591 or the ESL device 501 transmits the device notification transmission 558 with device notification information (e.g., notification information 542) to one or more non-ESL devices, sch as the wireless device 503. As another example, an ESL AP, such as ESL AP 604, 704, or ESL AP 802, transmits (e.g., relays) ESL notification information to one or more ESL devices or transmits device notification information to one or more non-ESL devices that it receives from an ESL server. Other examples are also described in FIGS. 6-16.

The wireless communication device (e.g., such as a UE or base station) may execute additional blocks (or the wireless communication device may be configured further to perform additional operations) in other implementations. For example, the wireless communication device may perform one or more operations as described with reference to FIGS. 5-11 or as described below. As another example, the wireless communication device may perform one or more aspects as presented below.

Accordingly, wireless communication devices may perform enhanced notification coexistence operations to dynamically and flexibly leverage ESL notification resources to output position or location based operations, such as to output multiple notifications concurrently in close proximity to one another. In some aspects, the wireless communication devices may utilize proximity based thresholds to determine when to perform the notification coexistence operations. Additionally, notification information may be provided to the devices to enable notification synching by the devices with the notifications output by the ESLs. Accordingly, the network performance and user experience may be increased due to increased notification bandwidth and clarity.

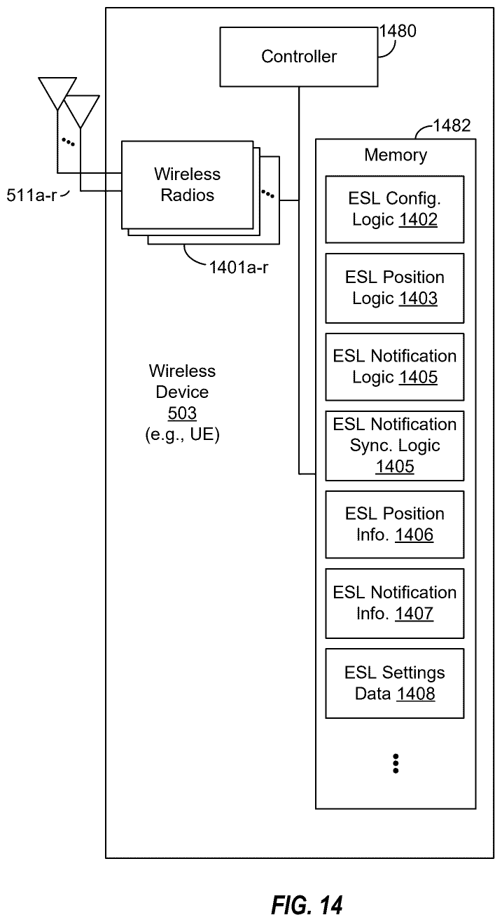

FIG. 14 is a block diagram illustrating wireless device 503 configured according to one aspect of the present disclosure. Wireless device 503 includes the structure, hardware, and components as illustrated for wireless device 503 of FIG. 5. For example, wireless device 503 includes controller/processor 1480, which operates to execute logic or computer instructions stored in memory 1482, as well as controlling the components of wireless device 503 that provide the features and functionality of wireless device 503. Wireless device 503, under control of controller/processor 1480, transmits and receives signals via wireless radios 1401a-r and antennas 511a-r. As illustrated in the example of FIG. 14, memory 1482 stores one or more of ESL configuration logic 1402, ESL position logic 1403, ESL notification logic 1404, ESL notification synchronization logic 1405, ESL position information 1406, ESL notification information 1407, or ESL settings data 1408. The data (1402-1408) stored in the memory 1682 may include or correspond to data and/or logic to enable the operations of FIGS. 5-16.

The wireless communication device (e.g., UE or base station) may execute additional blocks (or the wireless communication device may be configured further to perform additional operations) in other implementations. For example, the wireless communication device may perform one or more operations described above, such as described with reference to FIGS. 5-16 and any of the operations described below. As another example, the wireless communication device may perform one or more aspects as presented below.

Accordingly, wireless communication devices may perform enhanced notification coexistence operations to dynamically and flexibly leverage ESL notification resources to output position or location based operations, such as to output multiple notifications concurrently in close proximity to one another. In some aspects, the wireless communication devices may utilize proximity based thresholds to determine when to perform the notification coexistence operations. Additionally, notification information may be provided to the devices to enable notification synching by the devices with the notifications output by the ESLs. Accordingly, the network performance and user experience may be increased due to increased notification bandwidth and clarity.

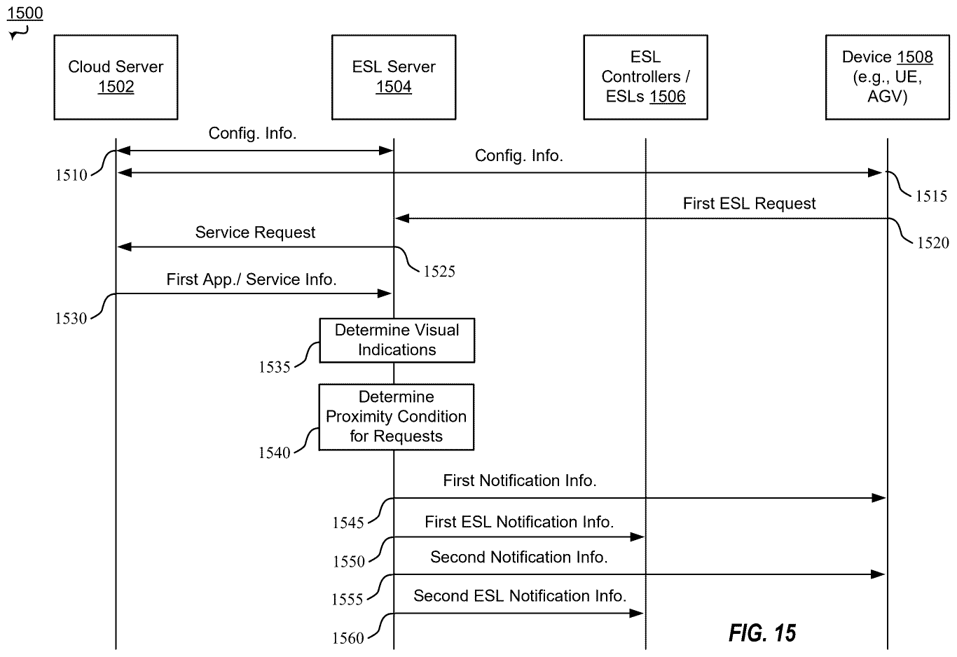

Referring to FIG. 15, FIG. 15 is a timing diagram 1500 illustrating an ESL system that supports notification coexistence operations according to one or more aspects. The example of FIG. 15 corresponds to an example of notification operations for a device interacting with the ESL system where notifications and indications are based on information stored at another server. The example of FIG. 15 may enable enhanced ESL notifications with additional functionality by enabling the ESL system to interact with other systems.

In the example of FIG. 15, the ESL system includes a cloud server 1502 (e.g., third-party application or service server), an ESL server 1504, ESL controllers 1506, and a device 1508 (e.g., non-ESL device or UE). Each of the ESL controllers 1506 may include or correspond to an ESL with a wireless radio or a wireless device/radio associated with a plurality of ESLs. Although illustrated as a cloud server 1502, the application or service server may be any third-party system and hosted in a location separate from the ESL system. Alternatively, the application or service server may correspond to a server of the ESL system or a databased stored on the ESL system or ESL server 1504.

Prior to 1510, the ESL system may be configured with initial position information and/or configurations for network operation and positioning determination as described with reference to FIGS. 6 and 7. At 1510, the cloud server 1502 and the ESL server 1504 may exchange configuration information, such as notification configuration information. For example, the cloud server 1502 may provide service information and/or user information to the ESL server 1504 for the ESL server 1504 to generate notifications with. To illustrate, the cloud server 1502 may provide user information, grocery list information, cart information, coupon information, rebate information, special pricing information, etc., or any combination thereof to the ESL server 1504. The cloud server 1502 and the ESL server 1504 may communicate with each other via a network or ethernet connection or via the Internet.

At 1515, the cloud server 1502 and the device 1508 may exchange configuration information, such as account and/or notification configuration information. For example, the device 1508 may provide user or account information to the cloud server 1502 for the cloud server 1502 to generate account profile information. As another example, the device 1508 may provide service or application information. To illustrate, the device 1508 may provide grocery list information, cart information, coupon information, rebate information, product information, etc., or any combination thereof to the cloud server 1502. The cloud server 1502 and the device 1508 may communicate with each other via a cellular network or the Internet, or via the ESL system.

At 1520, the device 1508 may generate and transmit an ESL request, such as an ESL notification request, to the ESL server 1504. The device 1508 generate and transmit the ESL request similar to the ESL requests transmitted to the ESL servers as described with reference to FIGS. 6 and 7. Additionally, or alternatively, the device 1508 may generate and transmit position information to the ESL server 1504 indicating a position of the device 1508. The position information may be generated based on measuring ESL beacons from the ESL controllers and/or based on device-based position information (e.g., GPS or gyroscope). In some aspects, the device 1508 may periodically transmit its position to the ESL server 1504, and the ESL server 1504 and cloud server 1502 may interact to provide the device 1508 with notifications for products around the device 1508 that a user thereof is associated with. Thus, the ESL server 1504 may provide the user with notifications relevant to products on a grocery list, products on an advertisement list or that match a profile of the user, etc., automatically based on the position of the device 1508.

At 1525, the ESL server 1504 communicates with the cloud server 1502 responsive to the ESL request. For example, the ESL server 1504 may generate an application or service request based on the received ESL request from the device 1508. To illustrate, the ESL server 1504 may request a grocery list associated with a user of the device 1508, a special price corresponding to a coupon or rebate associated with a user of the device 1508, etc.

At 1530, the cloud server 1502 responds to the request from the ESL server 1504. For example, the cloud server 1502 may transmit first application or service information to the ESL server 1504 based on the received request from the ESL server 1504 and for the device 1508. To illustrate, the cloud server 1502 may provide a list of items corresponding to a stored grocery list for the device 1508 and/or special pricing for the items, and the items may correspond to assets or products of the ESL system.

At 1535, the ESL server 1504 determines one or more notifications for the device 1508 based on the ESL request and the application/service information received from the cloud server 702. For example, the ESL server 1504 determines notifications for two products in the ESL system, such as directions or visual indication for two products of a customer list, similar to as described with reference to FIGS. 6 and 7.

At 1540, the ESL server 1504 optionally determines if the one or more notifications for the device 1508 and optionally if one or more other notifications of other devices satisfied a proximity condition, similar to as described with reference to FIGS. 6 and 7. If so, the ESL server 1504 may engage in in notification coexistence operations.

At 1545, the ESL server 1502 transmits first notification information to the device 1508. For example, the ESL server 1502 may transmit a notification transmission, such as the ESL notification transmission 556 and/or the device notification transmission 558 of FIG. 5 or th device notification transmission of FIG. 6 or 7. To illustrate, the ESL server 1502 may broadcast or unicast a transmission via the ELS system or via a network connection outside of the ELS system, as described with reference to FIGS. 6 and 7. The first notification may cause the device 1508 to output a notification or to identify a notification output by the ESL system, such as by a particular ESL controller thereof. The first notification may include or correspond to a first product of a list of the user and may indicate special pricing.

At 1550, the ESL server 1502 transmits first ESL notification information to one or more of the ESL controllers 1506. The ESL server 1502 may transmit the first ESL notification information to the ESL controllers via one or more ESL APs, as described with reference to FIGS. 6 and 7. The first ESL notification information may include or correspond to the first ESL notification information of FIGS. 5-7 and may cause one or more of the ESLs of the ESL controllers 1506 to output a first notification intended for the device 1508, such as any of the indications described herein. After receiving the first ESL notification information, one or more of the ESL controllers 1506 output a first notification based on the received ESL notification information as described with reference to FIGS. 6 and 7.

At 1555, the ESL server 1502 transmits second notification information to the device 1508. For example, the ESL server 1502 may transmit a second notification transmission, such as the ESL notification transmission 556 and/or the device notification transmission 558 of FIG. 5 or th device notification transmission of FIG. 6 or 7. To illustrate, the ESL server 1502 may broadcast or unicast a second transmission via the ELS system or via a network connection outside of the ELS system, as described with reference to FIGS. 6 and 7. The second notification may cause the device 1508 to output a second notification or to identify a second notification output by the ESL system, such as by a particular ESL controller thereof. The second notification may include or correspond to a second product of the list of the user and may indicate special pricing. Although the first and second notification information are illustrated in different transmissions in the example of FIG. 15, such may be included in the same transmission in other examples.

At 1560, the ESL server 1502 transmits second ESL notification information to one or more of the ESL controllers 1506. The ESL server 1502 may transmit the second ESL notification information to the ESL controllers via one or more ESL APs, as described with reference to FIGS. 6 and 7. The second ESL notification information may include or correspond to the second ESL notification information of FIGS. 5-7 and may cause one or more of the ESLs of the ESL controllers 1506 to output a second notification intended for the device 1508, such as any of the indications described herein. After receiving the second ESL notification information, one or more of the ESL controllers 1506 output a second notification based on the received ESL notification information as described with reference to FIGS. 6 and 7. Although the first and second ESL notification information are illustrated in different transmissions in the example of FIG. 15, such may be included in the same transmission in other examples.

In the above example, the device 1508 may be a smartphone. In other examples, the device 1508 may be an AGV or another smart device, like smart glasses. For example, a user or employee may be equipped with AR glasses that have a camera. The AR glasses may utilize computer vision methods to determine that a shelf requires restocking (e.g., items running out). ESL controllers 1506 may be used to detect a proximity to the AR glasses, and relay to the ELS server 1504 the current position estimate of the AR glasses. The position estimate (e.g., position/location information) of the AR user and the detected shelf information can be used at the ELS server 1504 to determine which shelf requires restocking. One benefit of this approach is that the AR user does not need to self-locate. The AR user can merely provide image data and/or a position or indication of which shelf (e.g., indicated by a distance and angle with respect to the AR user) requires restocking.

In the example of FIG. 15, the ESL system can interact with additional devices, additional ESL devices/servers or third-party devices/servers to provide additional services or applications via the ESL system and notifications thereof. The additional information may be used with or without the enhanced notification coexistence operations described herein. When used with the enhanced notification coexistence operations and increased notification density and potential customized notifications, the ESL system can provide multiple tailored, customized, and/or dynamic notifications to many users.

FIG. 16 is a block diagram 1600 illustrating two examples of ESL notification operations according to aspects of the present disclosure. In a first example 1602, an AGV 1610 is navigating an aisle of ESLs based on indications thereof. In the first example 1602, the AGV 1610 navigates to the end of the aisle based on ESLs on both sides of the aisle displaying a particular indication (e.g., flashing light, particular color, particular QR code, etc.). The AGV 1610 may stop when it gets to the end of the aisle, i.e., the last two ESLs on the right when the ESLs display a different indication or no indication. As an illustrative, non-limiting example, green and red lights may be used to indicate that the AGV 1610 move or stop. Thus, the ESL's may provide notifications which navigate or guide the AGV 1610 through the ESL environment (e.g., store or warehouse).

In a second example 1604, an AGV 1610 is navigating another aisle of ESLs based on indications thereof. In the second example 1605, the AGV 1610 navigates to a particular area (e.g., middle) of the aisle based on one or more ESLs on one side of the aisle displaying a particular indication (e.g., flashing light, particular color, particular QR code, etc.). The AGV 1610 may locate a particular product or asset in a particular location of the environment based on the particular indication. The AGV 1610 may then engage in stocking or retrieving operations or support an employe with socking or retrieving operations based on the visual notifications of the ESLs. As described herein, other types of indications may be used in addition to the visual indications or in alternative to the visual indications in the examples 1602 and 1604. Thus, the ESL's may provide notifications which navigate or guide the AGV 1610 to particular products or product areas within the ESL environment (e.g., store or warehouse) to enable stocking and/or retrieval operations.

In the implementations described herein, an ESL system or network may include an ESL cloud server, one or more ESL gateway servers or edge servers associated with the ESL cloud server, one or more ESL APs associated with each gateway or edge server, one or more ESL controllers associated with each ESL AP, one or more ESLs associated with each ESL controller, and one or more eTags associated with each ESL. In some implementations, the ESL system may include a plurality of energizers, which may be associated with multiple eTags of the plurality of the eTags.

In a first aspect, a device for wireless communication includes: at least one processor; and a memory coupled to the at least one processor, wherein the at least one processor is configured to cause the device to: receive a first electronic shelf label (ESL) notification request from a first device associated with a first ESL; receive a second ESL notification request from a second device associated with a second ESL; determine whether a first location of the first ESL and a second location of the second ESL satisfy a proximity condition; and transmit ESL notification indication information for the first ESL and the second ESL responsive to determining that the proximity condition is satisfied, the ESL notification indication information indicating a first notification for the first ESL different from a second notification for the second ESL.

In a second aspect, alone or in combination with the first aspect, the ESL notification indication information includes a visual indication.

In a third aspect, alone or in combination with one or more of the above aspects, the visual indication comprises a visual pattern indication.

In a fourth aspect, alone or in combination with one or more of the above aspects, the ESL notification indication information includes an audio indication, a haptic indication, or both.

In a fifth aspect, alone or in combination with one or more of the above aspects, the ESL notification indication information indicates a multi-faceted indication including two or more of a visual indication, an audio indication, or a haptic indication.

In a sixth aspect, alone or in combination with one or more of the above aspects, the at least one processor is further configured to cause the device to: transmit first notification information to the first device, wherein the first notification information corresponds to the first notification request and indicates a first notification for the first device to be output by the first ESL; and transmit second notification information to the second device, wherein the second notification information corresponds to the second notification request and indicates a second notification for the second device to be output by the second ESL.

In a seventh aspect, alone or in combination with one or more of the above aspects, the first notification information is transmitted outside of the ESL system.

In an eighth aspect, alone or in combination with one or more of the above aspects, the second notification information is transmitted via the ESL system.

In a ninth aspect, alone or in combination with one or more of the above aspects, the at least one processor configured to cause the device to transmit the second notification information to the second device includes to: transmit, to the ESL AP, the second notification information via Bluetooth or Wi-Fi, wherein the ESL AP relays the second notification information to the second device via Bluetooth or Wi-Fi.

In a tenth aspect, alone or in combination with one or more of the above aspects, the ESL notification indication information includes first notification information indicating a visual notification, an audio notification, a haptic notification, a radiofrequency notification, or a combination thereof, to be output by at least the first ESL.

In an eleventh aspect, alone or in combination with one or more of the above aspects, the first notification information is configured to cause a notification to be output by the first device to be synchronized with the notification output by the first ESL.

In a twelfth aspect, alone or in combination with one or more of the above aspects, the at least one processor configured to cause the device to determine that the proximity condition is satisfied includes to: determine a first location of the first ESL; determine a second location of the first ESL; determine a distance between the first location and the second location; and compare the distance between the first location and the second location and a distance threshold.

In a thirteenth aspect, alone or in combination with one or more of the above aspects, the at least one processor configured to cause the device to determine that the proximity condition is satisfied includes to: determine a first location of the first ESL; determine a second location of the first ESL; and determine whether an aisle proximity condition is satisfied based on the first location and the second location.

In a fourteenth aspect, alone or in combination with one or more of the above aspects, the at least one processor configured to cause the device to determine that the proximity condition is satisfied includes to: determine a first ESL group of the first ESL; determine a second ESL group of the first ESL; and determine whether an ESL group proximity condition is satisfied based on the first ESL group and the second ESL group.

In a fifteenth aspect, alone or in combination with one or more of the above aspects, the at least one processor is further configured to cause the device to: determine a first time associated with the first ESL notification request; determine a second time associated with the second ESL notification request; determine a time difference between the first time and the second time; compare the time difference to a time difference threshold; and determine to evaluate the proximity condition responsive to the time difference satisfying the time difference threshold.

In a sixteenth aspect, alone or in combination with one or more of the above aspects, the ESL notification indication information causes a particular display of an ESL controller to display a first indication and the particular display of the ESL controller to display a second indication, wherein the first indication is different from the second indication.

In a seventeenth aspect, alone or in combination with one or more of the above aspects, a starting time of the first notification is different than a starting time of the second notification.

In an eighteenth aspect, alone or in combination with one or more of the above aspects, the ESL notification indication information causes a first display of an ESL controller to display a first indication and a second display of the ESL controller or of a second ESL controller to display a second indication, wherein the first indication is different from the second indication.

In a nineteenth aspect, alone or in combination with one or more of the above aspects, the ESL notification indication information includes visual indication type information, visual indication periodicity information, visual indication duration information, or a combination thereof.

In a twentieth aspect, alone or in combination with one or more of the above aspects, the visual indication type includes color information, shape information, indicator location information, screen change information, a machine-readable code, structured-light, or a combination thereof.

In a twenty-first aspect, alone or in combination with one or more of the above aspects, the at least one processor configured to cause the device to receive the first notification request from the first device includes to: receive the first notification request via a network or cellular connection.

In a twenty-second aspect, alone or in combination with one or more of the above aspects, the at least one processor configured to cause the device to receive the second notification request from the second device includes to: receive, via an ESL AP, second notification information corresponding to the second notification request via Bluetooth or Wi-Fi, wherein the ESL AP relays the second notification information received from the second device via Bluetooth or Wi-Fi.

In a twenty-third aspect, alone or in combination with one or more of the above aspects, the first and second ESL are the same, or wherein the first ESL and the second ESL are different.

In a twenty-fourth aspect, alone or in combination with one or more of the above aspects, the first and second ESL are in a same ESL group, or wherein the first ESL and the second ESL are in different ESL groups.

In a twenty-fifth aspect, alone or in combination with one or more of the above aspects, the at least one processor is further configured to cause the device to: determine notification type information for the ESL notification indication information based on first ESL type information for the first ESL device, second ESL type information for the second device, or both.

In a twenty-sixth aspect, alone or in combination with one or more of the above aspects, the at least one processor configured to cause the device to: receive user profile information associated with the first device, wherein the user profile information correspond to a list of products of an ESL system that includes the first ESL and that are associated with the first device, wherein the ESL notification indication information is generated based on the user profile information.

In a twenty-seventh aspect, alone or in combination with one or more of the above aspects, the at least one processor is further configured to cause the device to: transmit first notification information to the first device, wherein the first notification information corresponds to the first ESL notification request and indicates a first notification for the first device to be output by the first ESL and indicates customized information for the first device based on the user profile information.

In a twenty-eighth aspect, alone or in combination with one or more of the above aspects, the at least one processor is further configured to cause the device to: receive position information from the first device; and transmit third notification information to the first device, a third ESL, or a combination thereof, based on the received position information and the user profile information.

In a twenty-ninth aspect, alone or in combination with one or more of the above aspects, the at least one processor is further configured to cause the device to: determine if the received position information from the first device is within a threshold distance to positions of products of the list of products based on the user profile information; and generating the third notification information based on the received position being within a threshold distance to one or more particular positions of one or more products from the list of products.

In a thirtieth aspect, a device for wireless communication comprises: at least one processor; and a memory coupled to the at least one processor, wherein the at least one processor is configured to cause the device to: receive a first electronic shelf label (ESL) notification request from a first device associated with a first ESL; receive a second ESL notification request from a second device associated with a second ESL; transmit notification report information indicating the first ESL notification request and the second ESL notification request, wherein a first location of the first ESL and a second location of the second ESL satisfy a proximity condition; and receive ESL notification indication information for the first ESL and the second ESL responsive to transmission of the notification report information, the ESL notification indication information indicating a first notification for the first ESL different from a second notification for the second ESL based on the proximity condition being satisfied.

In a thirty-first aspect, alone or in combination with one or more of the above aspects, the at least one processor is further configured to cause the device to: transmit the ESL notification indication information for the first ESL and the second ESL to one or more ESL devices, wherein the ESL notification indication information cause the one or more ESL devices to output the first notification and the second notification.

In a thirty-second aspect, a device for wireless communication includes: at least one processor; and a memory coupled to the at least one processor, wherein the at least one processor is configured to cause the device to: receive ESL notification indication information for a first ESL and a second ESL, the ESL notification indication information indicating a first notification for the first ESL different from a second notification for the second ESL based on a first location of the first ESL and a second location of the second ESL satisfying a proximity condition for ESL notifications; and instruct the first ESL to output the first notification via the first ESL.

In a thirty-third aspect, alone or in combination with the thirty-second aspect, the at least one processor is further configured to cause the device to: instruct the second ESL to output the second notification via the second ESL.

In a thirty-fourth aspect, a device for wireless communication includes: at least one processor; and a memory coupled to the at least one processor, wherein the at least one processor is configured to cause the device to: transmit a first electronic shelf label (ESL) notification request associated with a first ESL; and receive ESL notification indication information for the first ESL and a second ESL responsive to transmission of the first ESL notification request, the ESL notification indication information indicating a first notification for the first ESL different from a second notification for a second ESL based on a first location of the first ESL and a second location of the second ESL satisfying a proximity condition for ESL notifications.

In another aspect, a device for wireless communication includes: at least one processor; and a memory coupled to the at least one processor, wherein the at least one processor is configured to cause the device to: receive a first electronic shelf label (ESL) notification request from a first device associated with a first ESL; receive a second ESL notification request from a second device associated with the first ESL; determine whether a dual visual indication condition is satisfied based on the first ESL notification request and the second ESL notification request; and transmit ESL notification indication information for the first ESL responsive to determining that the dual visual indication condition is satisfied, the ESL notification indication information indicating a first visual notification to be displayed by the first ESL for the first device different from a second visual notification to be displayed by the second ESL for the second device.

In another aspect, a device for wireless communication includes: at least one processor; and a memory coupled to the at least one processor, wherein the at least one processor is configured to cause the device to: receive ESL notification indication information for a first ESL, the ESL notification indication information indicating a first visual notification to be displayed by the first ESL for a first device different from a second visual notification to be displayed by a second ESL for a second device based on a first location of the first ESL and a second location of the second ESL satisfying a proximity condition for ESL notifications; and instruct the first ESL to concurrently output the first visual notification for a first device and the second visual notification for a second device.

Components, the functional blocks, and the modules described herein with respect to the figures described above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A device for wireless communication, comprising:
at least one processor; and
a memory coupled to the at least one processor,
wherein the at least one processor is configured to cause the device to:
receive a first electronic shelf label (ESL) notification request from a first device associated with a first ESL;
receive a second ESL notification request from a second device associated with a second ESL;
determine whether a first location of the first ESL and a second location of the second ESL satisfy a proximity condition; and
transmit ESL notification indication information for the first ESL and the second ESL responsive to determining that the proximity condition is satisfied, the ESL notification indication information indicating a first notification for the first ESL different from a second notification for the second ESL.

2. The device of claim 1, wherein the ESL notification indication information includes a visual indication.

3. The device of claim 2, wherein the visual indication comprises a visual pattern indication.

4. The device of claim 1, wherein the ESL notification indication information includes an audio indication, a haptic indication, or both.

5. The device of claim 1, wherein the at least one processor is further configured to cause the device to:
transmit first notification information to the first device, wherein the first notification information corresponds to the first ESL notification request and indicates the first notification for the first device to be output by the first ESL; and
transmit second notification information to the second device, wherein the second notification information corresponds to the second ESL notification request and indicates the second notification for the second device to be output by the second ESL.

6. The device of claim 5, wherein the at least one processor configured to cause the device to transmit the second notification information to the second device includes to:
transmit, to an ESL AP, the second notification information via Bluetooth or Wi-Fi and configured to cause the ESL AP to relay the second notification information to the second device via Bluetooth or Wi-Fi.

7. The device of claim 1, wherein the ESL notification indication information includes first notification information indicating a visual notification, an audio notification, a haptic notification, a radiofrequency notification, or a combination thereof, to be output by at least the first ESL.

8. The device of claim 1, wherein the at least one processor configured to cause the device to determine that the proximity condition is satisfied includes to:
determine the first location of the first ESL;
determine the second location of the first ESL;
determine a distance between the first location and the second location; and
compare the distance between the first location and the second location and a distance threshold.

9. The device of claim 1, wherein the at least one processor configured to cause the device to determine that the proximity condition is satisfied includes to:
determine the first location of the first ESL;
determine the second location of the first ESL; and
determine whether an aisle proximity condition is satisfied based on the first location and the second location.

10. The device of claim 1, wherein the at least one processor configured to cause the device to determine that the proximity condition is satisfied includes to:
determine a first ESL group of the first ESL;
determine a second ESL group of the first ESL; and
determine whether an ESL group proximity condition is satisfied based on the first ESL group and the second ESL group.

11. The device of claim 1, wherein the at least one processor is further configured to cause the device to:
determine a first time associated with the first ESL notification request;
determine a second time associated with the second ESL notification request;
determine a time difference between the first time and the second time;
compare the time difference to a time difference threshold; and
determine to evaluate the proximity condition responsive to the time difference satisfying the time difference threshold.

12. The device of claim 1, wherein the ESL notification indication information causes a particular display of an ESL controller to display a first indication and the particular display of the ESL controller to display a second indication, wherein the first indication is different from the second indication.

13. The device of claim 1, wherein the ESL notification indication information causes a first display of an ESL controller to display a first indication and a second display of the ESL controller or of a second ESL controller to display a second indication, wherein the first indication is different from the second indication.

14. The device of claim 1, wherein the ESL notification indication information includes visual indication type information, visual indication periodicity information, visual indication duration information, or a combination thereof.

15. The device of claim 14, wherein the visual indication type information includes color information, shape information, indicator location information, screen change information, a machine-readable code, structured-light, or a combination thereof.

16. The device of claim 1, wherein the at least one processor is further configured to cause the device to:
determine notification type information for the ESL notification indication information based on first ESL type information for the first ESL, second ESL type information for the second ESL, or both.

17. The device of claim 1, wherein the at least one processor configured to cause the device to:
receive user profile information associated with the first device, wherein the user profile information correspond to a list of products of an ESL system that includes the first ESL and that are associated with the first device, wherein the ESL notification indication information is generated based on the user profile information.

18. The device of claim 17, wherein the at least one processor is further configured to cause the device to:
transmit first notification information to the first device, wherein the first notification information corresponds to the first ESL notification request and indicates a first notification for the first device to be output by the first ESL and indicates customized information for the first device based on the user profile information.

19. The device of claim 17, wherein the at least one processor is further configured to cause the device to:
receive position information from the first device;
determine if the received position information from the first device is within a threshold distance to positions of products of the list of products based on the user profile information;
generating third notification information based on the received position being within the threshold distance to one or more particular positions of one or more products from the list of products; and
transmit the third notification information to the first device, a third ESL, or a combination thereof, based on the received position information and the user profile information.

20. A method for wireless communication, comprising:
receiving a first electronic shelf label (ESL) notification request from a first device associated with a first ESL;
receiving a second ESL notification request from a second device associated with a second ESL;
determining whether a first location of the first ESL and a second location of the second ESL satisfy a proximity condition; and
transmitting ESL notification indication information for the first ESL and the second ESL responsive to determining that the proximity condition is satisfied, the ESL notification indication information indicating a first notification for the first ESL different from a second notification for the second ESL.
